(19) United States
(12) Patent Application Publication
(10) Pub. No.: US 2026/0360097 A1
(43) Pub. Date: Nov. 12, 2026

(54) METHOD AND DEVICE FOR ACQUIRING CONTENT RELATED TO TARGET OBJECT

(71) Applicant: Samsung Electronics Co., Ltd., Suwon-si, (KR)

(72) Inventors: Dongil SON, Suwon-si (KR); Sooryuh KIM, Suwon-si (KR); Chaeyeon SON, Suwon-si (KR); Sunggeun AHN, Suwon-si (KR); Kwangyong LIM, Suwon-si (KR); Bokun CHOI, Suwon-si (KR)

(21) Appl. No.: 19/733,218

(22) Filed: Jul. 7, 2026

Related U.S. Application Data
(63) Continuation of application No. PCT/KR2024/017056, filed on Nov. 1, 2024.

(30) Foreign Application Priority Data
Jan. 17, 2024 (KR) 10-2024-0007373
Feb. 16, 2024 (KR) 10-2024-0022891

(51) Int. Cl. G06T 19/00; G06F 3/01; G06F 3/04815; G06F 3/16; G06V 10/26; G06V 20/20

(52) U.S. Cl. CPC G06T 19/006; G06F 3/04815; G06F 3/165; G06V 10/26; G06V 20/20; G06F 3/012

(57) ABSTRACT

An electronic device is provided. The electronic device includes a display, memory, comprising one or more storage media, storing instructions, and one or more processors communicatively coupled to the display and the memory, wherein the instructions, when executed by the one or more processors individually or collectively, cause the electronic device to obtain image information corresponding to a target object determined among physical objects disposed in a physical space around the electronic device, obtain content related to the target object, based on the obtained image information and ambient information of the electronic device, deactivate an interaction object being manipulable in response to an input of a user, based on a condition regarding an output of the content being satisfied, and output the obtained content in an area corresponding to the target object through the display.

### CROSS-REFERENCE TO RELATED APPLICATION(S)

This application is a continuation application, claiming priority under 35 U.S.C. § 365(c), of an International application No. PCT/KR 2024/017056, filed on Nov. 1, 2024, which is based on and claims the benefit of a Korean patent application number 10-2024-0007373, filed on Jan. 17, 2024, in the Ministry of Intellectual Property (MOIP), and of a Korean patent application number 10-2024-0022891, filed on Feb. 16, 2024, in the Ministry of Intellectual Property (MOIP), the disclosure of each of which is incorporated by reference herein in its entirety.

### BACKGROUND

### 1. Field

The disclosure relates to a technique for obtaining content related to a target object.

### 2. Description of Related Art

Recently, virtual reality (VR), augmented reality (AR), and mixed reality (MR) technologies that utilize computer graphics technology are being developed. VR technology refers to technology that uses a computer to establish a virtual space that does not exist in the real world and then makes the virtual space feel like reality, while AR or MR technology refers to technology that superimposes computer-generated information onto the real world, that is, technology that allows real-time interaction with a user by combining the real world and virtual world.

Among these, AR and MR technologies are being utilized in conjunction with technologies in various fields (e.g., broadcasting technology, medical technology, and gaming technology). Representative examples of AR technology being applied in the broadcasting technology field include a case in which the weather map in front of a weathercaster giving a weather forecast on a television (TV) changes naturally or a case in which an advertising image that does not exist in the stadium during a sports broadcast is inserted into a screen and transmitted as if the advertising image is actually in the stadium.

A representative service that provides AR or MR to a user is the metaverse. This metaverse is a compound word of ‘meta,’ meaning fiction or abstraction, and ‘universe,’ meaning the real world, and refers to a three-dimensional (3D) virtual world. The metaverse is a more advanced concept than the existing term, “virtual reality environment,” and provides an AR environment in which virtual worlds, such as the web and the internet, are absorbed into the real world.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a technique for obtaining content related to a target object.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, including one or more storage media, storing instructions, and one or more processors communicatively coupled to the display and the memory, wherein the instructions, when executed by the one or more processors individually or collectively, cause the electronic device to obtain image information corresponding to a target object determined among physical objects disposed in a physical space around the electronic device, obtain content related to the target object, based on the obtained image information and ambient information of the electronic device, deactivate an interaction object being manipulable in response to an input of a user, based on a condition regarding an output of the content being satisfied, and output the obtained content in an area corresponding to the target object through the display.

In accordance with another aspect of the disclosure, a method performed by an electronic device is provided. The method includes obtaining image information corresponding to a target object determined among physical objects disposed in a physical space around the electronic device, obtaining content related to the target object, based on the obtained image information and ambient information of the electronic device, deactivating an interaction object being manipulable in response to an input of a user based on a condition regarding an output of the content being satisfied, and outputting the obtained content in an area corresponding to the target object through the display.

In accordance with another aspect of the disclosure, one or more non-transitory computer-readable storage media storing one or more computer programs including computer-executable instructions that, when executed by one or more processors of an electronic device individually or collectively, cause the electronic device to perform operations. The operations include obtaining image information corresponding to a target object determined among physical objects disposed in a physical space around the electronic device, obtaining content related to the target object, based on the obtained image information and ambient information of the electronic device, deactivating an interaction object being manipulable in response to an input of a user based on a condition regarding an output of the content being satisfied, and outputting the obtained content in an area corresponding to the target object through a display.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description, taken in conjunction with the accompanying drawings, in which:

FIG. 1 is a block diagram illustrating a configuration of an electronic device according to an embodiment of the disclosure;

FIG. 2 illustrates an example of an optical see-through (OST) device according to an embodiment of the disclosure;

FIG. 3 illustrates an example of an optical system of an eye-tracking (ET) camera, a transparent member, and a display according to an embodiment of the disclosure;

FIGS. 4A and 4B are diagrams illustrating examples of a front view and a rear view of an electronic device according to various embodiments of the disclosure;

FIG. 5 illustrates an example of construction of a virtual space and an input from and an output to a user in the virtual space according to an embodiment of the disclosure;

FIG. 6 illustrates an example of an operation in which an electronic device provides a space to a user according to an embodiment of the disclosure;

FIG. 7 is a flowchart illustrating an example of a method of outputting content related to a target object by an electronic device according to an embodiment of the disclosure;

FIG. 8 illustrates an example of an operation in which an electronic device provides a stereoscopic image of a space according to an embodiment of the disclosure;

FIG. 9 is a diagram illustrating an example of an operation in which an operation mode of an electronic device transitions between a normal operation mode and a relaxation operation mode when a target object is a movable object, according to an embodiment of the disclosure;

FIG. 10 is a diagram illustrating an example of an operation in which an operation mode of an electronic device transitions between a normal operation mode and a relaxation operation mode when displaying a scene in an internal area of a target object, according to an embodiment of the disclosure;

FIG. 11 is a diagram illustrating an example of an operation in which an electronic device obtains content based on a content generation model according to an embodiment of the disclosure;

FIG. 12 is a diagram illustrating an example of an operation in which an electronic device outputs content in an area larger than an area corresponding to a target object according to an embodiment of the disclosure;

FIG. 13 is a diagram illustrating an example of a configuration in which an electronic device obtains and/or outputs content when a plurality of target objects are selected according to an embodiment of the disclosure; and

FIG. 14 is a block diagram illustrating an example of a configuration of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

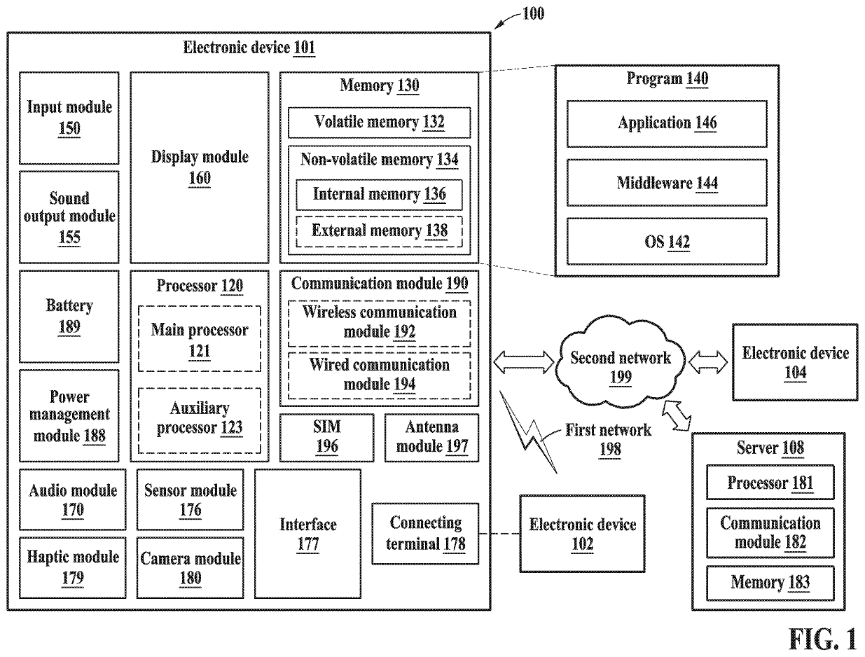

FIG. 1 is a block diagram illustrating a configuration of an electronic device according to an embodiment of the disclosure.

FIG. 1 is a block diagram illustrating an electronic device 101 in a network environment 100 according to various embodiments. Referring to FIG. 1, an electronic device 101 in a network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The AI model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate form, or as part of the speaker.

The display module 160 (e.g., a display) may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electric signal or vice versa. According to an embodiment, the audio module 170 may obtain the sound via the input module 150, or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the components described above may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199.

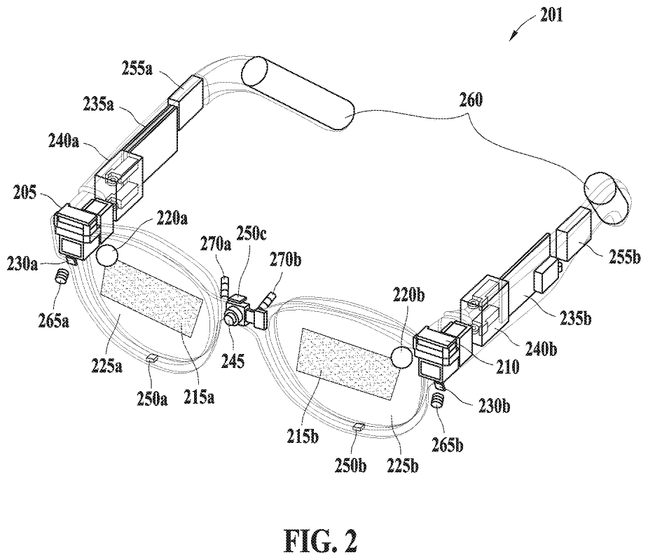

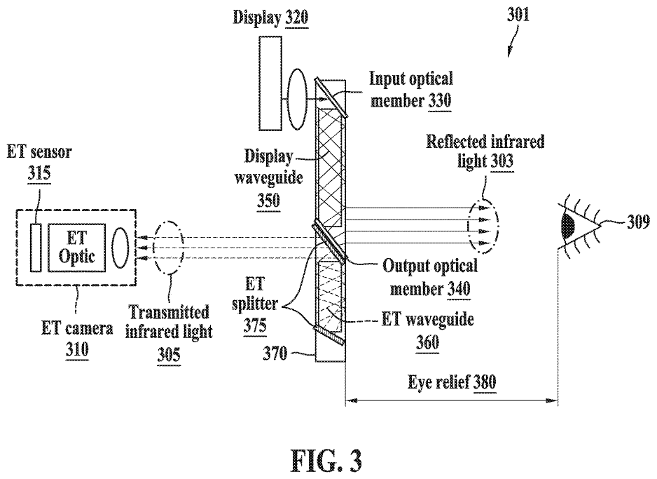

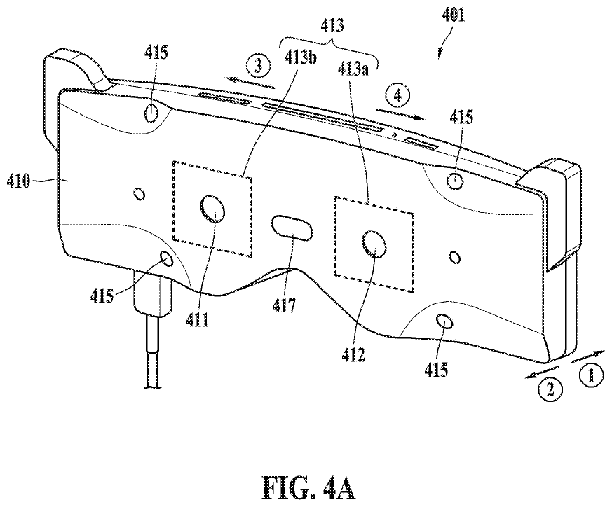

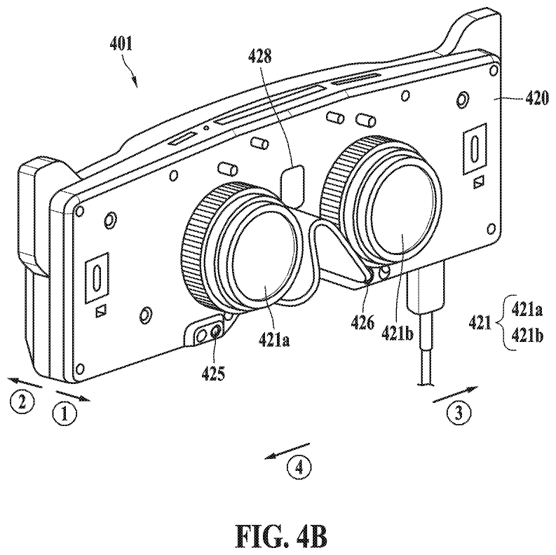

Each of the external electronic devices 102 and 104, and the server 108 may be a device of the same type as or a different type from the electronic device 101. According to an embodiment, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transmit an outcome of the performing to the electronic device 101. The electronic device 101 may provide the outcome, with or without further processing of the outcome, as at least part of a reply to the request. In the disclosure, an example in which the electronic device 101 is an augmented reality (AR) device (e.g., an electronic device 201 of FIG. 2, an electronic device 301 of FIG. 3, or an electronic device 401 of FIGS. 4A and 4B), and the server 108 among the external electronic devices 102 and 104, and the server 108 transmits, to the electronic device 101, a result of executing a virtual space and an additional function or service associated with the virtual space will be mainly described.

The server 108 may include a processor 181, a communication module 182, and memory 183. The processor 181, the communication module 182, and the memory 183 may be similarly configured to the processor 120, the communication module 190, and the memory 130 of the electronic device 101. For example, the processor 181 may provide a virtual space and an interaction between users in the virtual space by executing instructions stored in the memory 183. The processor 181 may generate at least one of visual information, auditory information, or tactile information of the virtual space and objects in the virtual space. For example, as the visual information, the processor 181 may generate rendered data (e.g., visual rendered data) obtained by rendering an appearance (e.g., a shape, size, color, or texture) of the virtual space and an appearance (e.g., a shape, size, color, or texture) of an object positioned in the virtual space. Additionally, the processor 181 may generate rendered data obtained by rendering changes (e.g., a change in an appearance of an object, sound generation, or tactile sensation generation) based on at least one of an interaction between objects (e.g., a physical object, a virtual object, or an avatar object) in the virtual space, or a user input to an object (e.g., a physical object, virtual object, or avatar object). The communication module 182 may establish communication with a first electronic device (e.g., the electronic device 101) of a user and a second electronic device (e.g., the electronic device 102) of another user. The communication module 182 may transmit at least one of visual information, tactile information, or auditory information described above to the first electronic device and the second electronic device. For example, the communication module 182 may transmit rendered data.

For example, after rendering content data executed by an application, the server 108 may transmit the content data to the electronic device 101 and the electronic device 101 receiving the data may output the content data to the display module 160. When the electronic device 101 detects a movement of a user through an inertial measurement unit (IMU) sensor or the like, the processor 120 of the electronic device 101 may correct the rendered data received from the external electronic device 102 based on the movement information and output the corrected movement information to the display module 160. Alternatively, the processor may transmit the information of the movement to the server 108 to request rendering such that screen data is updated accordingly. However, embodiments are not limited thereto, and the rendering may be performed by various types of external electronic devices (e.g., 102 and 104) such as a smartphone or a case device for storing and charging the electronic device 101. The rendered data corresponding to the virtual space generated by the external electronic devices 102 and 104 may be provided to the electronic device 101. In another example, the electronic device 101 may receive virtual spatial information (e.g., vertex coordinates, texture, and color defining a virtual space) and object information (e.g., vertex coordinates, texture, and color defining an appearance of an object) from the server 108 and perform rendering by itself based on the received data.

FIG. 2 illustrates an example of an optical see-through (OST) device according to an embodiment of the disclosure.

Referring to FIG. 2, an electronic device 201 may include at least one of a display (e.g., the display module 160 of FIG. 1), a vision sensor, light sources 230a and 230b, an optical element, or a substrate. The electronic device 201 of which the display is transparent and provides an image through the transparent display may be referred to as an OST device.

For example, the display may include a liquid crystal display (LCD), a digital mirror device (DMD), a liquid crystal on silicon (LCoS), an organic light-emitting diode (OLED), or a micro light-emitting diode (micro-LED).

In an embodiment, when the display is one of an LCD, a DMD, or an LCoS, the electronic device 201 may include the light sources 230a and 230b configured to emit light to a screen output area (e.g., screen display portions 215a and 215b) of the display. In another embodiment, when the display is capable of generating light by itself, for example, when the display is either the OLED or the micro-LED, the electronic device 201 may provide a virtual image with a relatively high quality to a user even though the separate light sources 230a and 230b are not included. In an embodiment, when the display is implemented as an OLED or a micro LED, a light source 230a or 230b may be unnecessary, and accordingly the electronic device 201 may be reduced in weight.

Referring again to FIG. 2, the electronic device 201 may include a display, a first transparent member 225a and/or a second transparent member 225b. A user may use the electronic device 201 while wearing the electronic device 201 on their face. The first transparent member 225a and/or the second transparent member 225b may be formed of a glass plate, a plastic plate, or a polymer, and may be transparently or translucently formed. According to an embodiment, the first transparent member 225a may be disposed to face the right eye of the user, and the second transparent member 225b may be disposed to face the left eye of the user. The display may include a first display 205 configured to output a first image (e.g., a right image) corresponding to the first transparent member 225a and a second display 210 configured to output a second image (e.g., a left image) corresponding to the second transparent member 225b. In an embodiment, when each of the displays is transparent, the displays and transparent members may be disposed at positions facing the user's eyes to configure the screen display portions 215a and 215b.

In an embodiment, the light emitted from the display 205 or 210 may be guided by the waveguide through the input optical member 220a or 220b. Light moving into the display waveguide may be guided toward eyes of a user through an output optical member (e.g., an output optical member 340 of FIG. 3). The screen display portions 215a and 215b may be determined based on light emitted toward the eyes of the user.

For example, the light emitted from the displays 205 and 210 may be reflected from a grating region of the waveguide formed in the input optical members 220a and 220b and the screen display portions 215a and 215b, and may be transmitted to the eyes of the user.

The optical element may include at least one of a lens or an optical waveguide.

The lens may adjust a focus such that a screen output to the display is visible to the eyes of the user. The lens may include, for example, at least one of a Fresnel lens, a pancake lens, or a multichannel lens.

The optical waveguide may transmit an image ray generated by the display to the eyes of the user. For example, the image ray may represent a ray of light that is emitted by the light source 230a or 230b and passes through the screen output region of the display. The optical waveguide may be formed of glass, plastic, or polymer. The optical waveguide may include a nanopattern formed on a portion of an inner surface or a portion of an outer surface, for example, a grating structure of a polygonal or a curved shape. A structure of the waveguide is described below with reference to FIG. 3.

The vision sensor may include at least one of a camera or a depth sensor.

First cameras 265a and 265b, which are recognition cameras, may be cameras used for 3 degrees of freedom (DoF) or 6 DoF head tracking, hand detection, hand tracking, and space recognition. The first cameras 265a and 265b may mainly include a global shutter (GS) camera. Since a stereo camera is required for head tracking and space recognition, the first cameras 265a and 265b may include two or more GS cameras. A GS camera may have a more excellent performance compared to a rolling shutter (RS) camera, in terms of detecting and tracking a fine movement, such as a quick movement of a hand or a finger. For example, the GS camera may have a low image blur. The first cameras 265a and 265b may capture image data used for a simultaneous localization and mapping (SLAM) function through depth capturing and space recognition for 6 DoF. In addition, a user gesture recognition function may be performed based on image data captured by the first cameras 265a and 265b.

Second cameras 270a and 270b, which are eye-tracking (ET) cameras, may be used to capture image data for detecting and tracking the pupils of the user. The second cameras 270a and 270b are described with reference to FIG. 3 below.

A third camera 245 may be a camera for image capturing. The third camera 245 may include a high-resolution (HR) camera to capture an HR image or a photo video (PV) image. The third camera 245 may include a color camera having functions for obtaining a high-quality image, such as, an automatic focus (AF) function and an optical image stabilizer (OIS). The third camera 245 may be a GS camera or an RS camera.

A fourth camera (e.g., face recognition cameras 425 and 426 of FIGS. 4A and 4B below) is a face recognition camera, and a face-tracking (FT) camera may be used to detect and track facial expressions of the user.

A depth sensor (not shown) may be a sensor configured to sense information for determining a distance to an object such as time of flight (TOF). The TOF is technology for measuring a distance to an object using a signal (e.g., a near infrared ray, ultrasound, laser, etc.). A depth sensor based on the TOF technique may transmit a signal from a transmitter, may measure the signal in a receiver, and may measure a TOF of the signal.

The light sources 230a and 230b (e.g., illumination modules) may include an element (e.g., an LED) configured to emit light of various wavelengths. The illumination module may be attached to various positions depending on the purpose. In an example of use, a first illumination module (e.g., an LED element), attached around a frame of an AR glasses device, may emit light for assisting gaze detection when tracking a movement of the eyes with an ET camera. The first illumination module may include, for example, an IR LED of an infrared wavelength. In another example of use, a second illumination module (e.g., an LED element) may be attached around hinges 240a and 240b connecting a frame and a temple or attached in proximity to a camera mounted around a bridge connecting the frame. The second illumination module may emit light for supplementing ambient brightness when the camera captures an image. When a subject is not easily detected in a dark environment, the second illumination module may emit light.

A substrate 235a or 235b (e.g., a PCB) may support the aforementioned components.

The PCB may be disposed on a temple of glasses. A flexible PCB (FPCB) may transmit an electrical signal to each module (e.g., a camera, a display, an audio module, and a sensor module) and another PCB. In an embodiment, at least one PCB may include a first substrate, a second substrate, and an interposer disposed between the first substrate and the second substrate. An electrical signal may be transmitted to each module and the other PCB.

The other components may include, for example, at least one of a plurality of microphones (e.g., a first microphone 250a, a second microphone 250b, and a third microphone 250c), a plurality of speakers (e.g., a first speaker 255a and a second speaker 255b), a battery 260, an antenna, or a sensor (e.g., an acceleration sensor, a gyro sensor, a touch sensor, etc.).

FIG. 3 illustrates an example of an optical system of an eye-tracking (ET) camera, a transparent member, and a display according to an embodiment of the disclosure.

FIG. 3 is a diagram illustrating an operation of an ET camera included in an electronic device, according to an embodiment.

Referring to FIG. 3, a process in which an ET camera 310 (e.g., a first ET camera 270a and a second ET camera 270b of FIG. 2) of the electronic device 301 according to an embodiment tracks an eye 309 of the user, that is, a gaze of the user, using light (e.g., infrared light) output from a display 320 (e.g., the first display 205 and the second display 210 of FIG. 2) is illustrated.

A second camera (e.g., the second cameras 270a and 270b of FIG. 2) may be the ET camera 310 that collects information for positioning the center of a virtual image projected onto the electronic device 301 according to a direction at which pupils of a wearer of the electronic device 301 gaze. The second camera may also include a GS camera to detect the pupils and track the rapid movement of the pupils. The ET cameras may be installed for the right eye and the left eye, and the ET cameras having the same camera performance and specifications may be used. The ET camera 310 may include an eye gaze tracking sensor 315. The eye tracking sensor 315 may be included inside the eye tracking camera 310. The infrared light output from the display 320 may be transmitted as reflected infrared light 303 to the eye 309 of the user by a half mirror. The ET sensor 315 may detect transmitted infrared light 305 that is generated when the reflected infrared light 303 is reflected from the eye 309 of the user. The ET camera 310 may track the eye 309 of the user, that is, the gaze of the user, based on the result of the detection by the ET sensor 315.

The display 320 may include a plurality of visible light pixels and a plurality of infrared pixels. The visible light pixels may include R, G, and B pixels. The visible light pixels may output visible light corresponding to a virtual object image. The infrared pixels may output infrared light. The display 320 may include, for example, micro LEDs or OLEDs.

A display waveguide 350 and an ET waveguide 360 may be included in a transparent member 370 (e.g., the first transparent member 225a and the second transparent member 225b of FIG. 2). The transparent member 370 may be formed as, for example, a glass plate, a plastic plate, or a polymer and may be transparently or translucently formed. The transparent member 370 may be disposed to face an eye of a user. In this case, a distance between the transparent member 370 and the eye 309 of the user may be referred to as an “eye relief” 380.

The transparent member 370 may include the display waveguide 350 and the eye tracking waveguide 360. The transparent member 370 may include the input optical member 330 and the output optical member 340. In addition, the transparent member 370 may include an ET splitter 375 that splits input light into several waveguides.

According to an embodiment, light incident to one end of the display waveguide 350 may be propagated inside the display waveguide 350 by a nanopattern and may be provided to a user. In addition, the display waveguide 350 formed of a free-form prism may provide incident light as an image ray to the user through a reflection mirror. The display waveguide 350 may include at least one of a diffractive element (e.g., a diffractive optical element (DOE) or a holographic optical element (HOE)) or a reflective element (e.g., a reflection mirror). The display waveguide 350 may guide display light (e.g., an image ray) emitted from the light source to the eyes of the user, using at least one of the diffractive element or the reflective element included in the display waveguide 350. For reference, although FIG. 3 illustrates that the output optical member 340 is separate from the ET waveguide 360, the output optical member 340 may be included in the ET waveguide 360.

According to various embodiments, the diffractive element may include the input optical member 330 and the output optical member 340. For example, the input optical member 330 may refer, for example, to an “input grating region.” The output optical member 340 may refer, for example, to an “output grating region.” The input grating region may serve as an input end that diffracts (or reflects) light, that is output from a micro-LED, to transmit the light to a transparent member (e.g., a first transparent member and a second transparent member) of a screen display portion. The output grating region may serve as an exit that diffracts (or reflects), to the eyes of the user, the light transmitted to the transparent member (e.g., the first transparent member and the second transparent member) of a waveguide.

According to an embodiment, a reflective element may include a total reflection waveguide or a total reflection optical element for total internal reflection (TIR). For example, TIR, which is one of schemes for inducing light, may form an angle of incidence such that light (e.g., a virtual image) entering through the input grating region is completely reflected from one surface (e.g., a specific surface) of the waveguide, to completely transmit the light to the output grating region.

In an embodiment, the light emitted from the display 320 may be guided by the waveguide through the input optical member 330. The light moving into the waveguide may be guided toward the eyes of the user through the output optical member 340. The screen display portion may be determined based on the light emitted toward the eyes of the user.

FIGS. 4A and 4B are diagrams illustrating examples of a front view and a rear view of an electronic device, according to various embodiments of the disclosure.

FIG. 4A may be an appearance of an electronic device 401 viewed in a first direction \textcircled{1}, and FIG. 4B may be an appearance of the electronic device 401 viewed in a second direction \textcircled{2}. When a user wears the electronic device 401, the appearance viewed by the user's eyes may be illustrated in FIG. 4B.

Referring to FIG. 4A, according to various embodiments, the electronic device 401 (e.g., the electronic device 101 of FIG. 1, the electronic device 201 of FIG. 2, or the electronic device 301 of FIG. 3) may provide a service providing an extended reality (XR) experience to the user. For example, the XR or XR service may be defined as a service that collectively refers to virtual reality (VR), AR, and/or mixed reality (MR).

According to an embodiment, the electronic device 401 may refer to a head-mounted device or head-mounted display (HMD) worn on the head of the user but may be provided in the form of at least one of glasses, goggles, a helmet, or a hat. The electronic device 401 may include some types such as an OST type configured such that, when being worn, external light reaches the eyes of the user through glasses or a video see-through (VST) type configured such that, when being worn, light emitted from a display reaches the eyes of the user but external light is blocked not to reach the eyes of the user.

According to an embodiment, the electronic device 401 may be worn on the head of the user and provide images related to an XR service to the user. For example, the electronic device 401 may provide XR content (hereinafter, also referred to as an XR content image) that is output such that at least one virtual object appears overlaid in a display region or in a region determined to be a field of view (FoV) of the user. According to an embodiment, the XR content may refer to an image related to a real space obtained through a camera (e.g., an image-capturing camera) or an image or video in which at least one virtual object is added to a virtual space. According to an embodiment, the electronic device 401 may provide XR content based on a function being performed by the electronic device 401 and/or a function being performed by one or more external electronic devices of external electronic devices (e.g., the electronic devices 102 and 104 of FIG. 1 and the server 108 of FIG. 1).

According to an embodiment, the electronic device 401 may be at least partially controlled by an external electronic device (e.g., the electronic device 102 or 104 of FIG. 1), or may perform at least one function under the control of the external electronic device or perform at least one function independently.

Referring to FIG. 4A, a vision sensor may be disposed on a first surface of a housing of a main body 410 of the electronic device 401. The vision sensor may include cameras (e.g., second function cameras 411 and 412, and first function cameras 415) and/or a depth sensor 417 for obtaining information related to the surrounding environment of the electronic device 401.

In an embodiment, the second function cameras 411 and 412 may obtain images related to the surrounding environment of the electronic device 401. With a wearable electronic device worn by the user, the first function cameras 415 may obtain images. The first function cameras 415 may be used for hand detection and tracking, and recognition of gestures (e.g., hand gestures) of the user. The first function cameras 415 may be used for 3 DoF and 6 DoF head tracking, position (space, environment) recognition, and/or movement recognition. In an embodiment, the second function cameras 411 and 412 may also be used for hand detection and tracking, and the recognition of user gestures.

In an embodiment, the depth sensor 417 may be configured to transmit a signal and receive a signal reflected from an object and may be used to determine a distance to an object based on the TOF. Alternatively of or additionally, the cameras 411, 412, and 415 may determine the distance to the object in place of the depth sensor 417.

Referring to FIG. 4B, the face recognition cameras 425 and 426 and/or a display 421 (and/or a lens) may be disposed on a second surface 420 of the housing of the main body 410.

In an embodiment, the face recognition cameras 425 and 426 adjacent to a display may be used to recognize the face of the user or may recognize and/or track both eyes of the user.

In an embodiment, the display 421 (and/or a lens) may be disposed on the second surface 420 of the electronic device 401. In an embodiment, the electronic device 401 may not include some of the plurality of cameras 415. Although not shown in FIGS. 4A and 4B, the electronic device 401 may further include at least one of the components shown in FIG. 2.

According to an embodiment, the electronic device 401 may include the main body 410 on which at least some of the components of FIG. 1 are mounted, the display 421 (e.g., the display module 160 of FIG. 1) disposed in the first direction \textcircled{1} of the main body 410, the first function cameras 415 (e.g., recognition cameras) disposed in the second direction \textcircled{2} of the main body 410, the second function cameras 411 and 412 (e.g., image-capturing cameras) disposed in the second direction \textcircled{2}, a third function camera 428 (e.g., an ET camera) disposed in the first direction \textcircled{1}, fourth function cameras 425 and 426 (e.g., face recognition cameras) disposed in the first direction \textcircled{1}, the depth sensor 417 disposed in the second direction \textcircled{2}, and a touch sensor 413 disposed in the second direction \textcircled{2}. Although not shown in the drawings, the main body 410 may include memory (e.g., the memory 130 of FIG. 1) and a processor (e.g., the processor 120 of FIG. 1) therein and may further include other components shown in FIG. 1.

According to an embodiment, the display 421 may include an LCD, a DMD, an LCoS device, an OLED, or a micro-LED.

In an embodiment, when the display 421 is one of an LCD, a DMD, or an LCoS device, the electronic device 401 may include a light source that emits light to a screen output region of the display 421. In another embodiment, when the display 421 is capable of generating light by itself, for example, when the electronic device 401 is formed of one of an OLED or a micro-LED, the electronic device 401 may provide an XR content image with a relatively high quality to the user, even though a separate light source is not included. In an embodiment, when the display 421 is implemented as an OLED or a micro-LED, a light source may be unnecessary, which may lead to lightening of the electronic device 401.

According to an embodiment, the display 421 may include a first transparent member 421a and/or a second transparent member 421b. The user may use the electronic device 401 with the electronic device 401 worn on the face. The first transparent member 421a and/or the second transparent member 421b may be formed of a glass plate, a plastic plate, or a polymer and may be transparently or translucently formed. According to an embodiment, the first transparent member 421a may be disposed to face the left eye of the user in a fourth direction \textcircled{4}, and the second transparent member 421b may be disposed to face the right eye of the user in a third direction \textcircled{3}. According to various embodiments, when the display 421 is transparent, the display 421 may be disposed at a position facing the eyes of the user to form a display area.

According to an embodiment, the display 421 may include a lens including a transparent waveguide. The lens may serve to adjust the focus such that a screen (e.g., an XR content image) output to the display 421 is to be viewed by the eyes of the user. For example, light emitted from a display panel may pass through the lens and be transmitted to the user through the waveguide formed within the lens. The lens may include, for example, a Fresnel lens, a pancake lens, or a multichannel lens.

An optical waveguide (e.g., a waveguide) may serve to transmit a light source generated by the display 421 to the eyes of the user. The optical waveguide may be formed of glass, plastic, or a polymer and may have a nanopattern formed on a portion of an inner or outer surface, for example, a grating structure of a polygonal or curved shape. According to an embodiment, light incident to one end of the optical waveguide, that is, an output image of the display 421 may be propagated inside the optical waveguide to be provided to the user. In addition, the optical waveguide formed of a free-form prism may provide the incident light to the user through a reflection mirror. The optical waveguide may include at least one of diffractive elements (e.g., a DOE and an HOE) or at least one of reflective elements (e.g., a reflection mirror). The optical waveguide may guide an image output from the display 421 to the eyes of the user using the at least one diffractive element or reflective element included in the optical waveguide.

According to an embodiment, the diffractive element may include an input optical member/output optical member (not shown). For example, the input optical member may refer to an input grating region, and the output optical member (not shown) may refer to an output grating region. The input grating region may serve as an input end that diffracts (or reflects) light, output from a light source (e.g., a micro-LED), to transmit the light to a transparent member (e.g., the first transparent member 421a and the second transparent member 421b) of the display area. The output grating region may serve as an exit that diffracts (or reflects), to the eyes of the user, the light transmitted to the transparent member (e.g., the first transparent member and the second transparent member) of the optical waveguide.

According to various embodiments, the reflective element may include a TIR optical element or a TIR waveguide for TIR. For example, TIR, which is a scheme for guiding light, may generate an angle of incidence such that light (e.g., a virtual image) input through the input grating region is substantially completely reflected from one surface (e.g., a specific surface) of the optical waveguide, to completely transmit the light to the output grating region.

In an embodiment, a light path of light emitted from the display 421 may be guided by the waveguide through the input optical member. Light moving into the optical waveguide may be guided toward the eyes of the user through the output optical member. The display area may be determined based on the light emitted in the direction of the eyes.

According to an embodiment, the electronic device 401 may include a plurality of cameras. For example, the cameras may include the first function cameras 415 (e.g., recognition cameras) disposed in the second direction \textcircled{2} of the main body 410, the second function cameras 411 and 412 (e.g., image-capturing cameras) disposed in the second direction \textcircled{2}, the third function camera 428 (e.g., an ET camera) disposed in the first direction \textcircled{1}, and/or the fourth function cameras 425 and 426 (e.g., the face recognition cameras) disposed in the first direction \textcircled{1}, and may further include other function cameras (not shown).

The first function cameras 415 (e.g., the recognition cameras) may be used for a function of detecting a movement of the user or recognizing a gesture of the user. The first function cameras 415 may support at least one of head tracking, hand detection and hand tracking, and space recognition. For example, the first function cameras 415 may mainly use a GS camera having excellent performance compared to an RS camera to detect and track fine gestures or movements of hands and fingers and may be configured as a stereo camera including two or more GS cameras for head tracking and space recognition. The first function cameras 415 may perform functions, such as, 6DoF space recognition, and a SLAM function for recognizing information (e.g., a position and/or direction) associated with a surrounding space through depth imaging.

The second function cameras 411 and 412 (e.g., the image-capturing cameras) may be used to capture images of the outside, generate an image or video corresponding to the outside, and transmit the image or video to a processor (e.g., the processor 120 of FIG. 1). The processor may display the image provided from the second function cameras 411 and 412 on the display 421. The second function cameras 411 and 412 may also be referred to as HR or PV cameras and may include an HR camera. For example, the second function cameras 411 and 412 may include color cameras equipped with a function for obtaining high-quality images, such as an AF function and OIS, but are not limited thereto. The second function cameras 411 and 412 may also include a GS camera or an RS camera.

The third function camera 428 (e.g., the ET camera) may be disposed on the display 421 (or inside the main body) such that camera lenses face the eyes of the user when the user wears the electronic device 401. The third function camera 428 may be used for detecting and tracking the pupils (e.g., ET). The processor may verify a gaze direction by tracking movements of the left eye and the right eye of the user in an image received from the third function camera 428. By tracking the positions of the pupils in the image, the processor may be configured such that the center of an XR content image displayed on the display area is positioned according to a direction in which the pupils are gazing. For example, the third function camera 428 may use a GS camera to detect the pupils and track the movements of the pupils. The third function camera 428 may be installed for each of the left eye and the right eye, and may have the same camera performance and specifications.

The fourth function cameras (e.g., the face recognition cameras 425 and 426) may be used to detect and track a facial expression of the user (e.g., FT) when the user wears the electronic device 401.

According to an embodiment, the electronic device 401 may include a lighting unit (e.g., LED) (not shown) as an auxiliary means for cameras. For example, the third function camera 428 may use a lighting unit included in a display as an auxiliary means for facilitating gaze detection when tracking eye movements, to direct emitted light (e.g., IR LED of an IR wavelength) toward both eyes of the user. In another example, the second function cameras 411 and 412 may further include a lighting unit (e.g., a flash) as an auxiliary means for supplementing surrounding brightness when capturing an image of the outside.

According to an embodiment, the depth sensor 417 (or a depth camera) may be used to verify a distance to an object (e.g., a target) through, for example, TOF. TOF, which is technology for measuring a distance to an object using a signal (e.g., near-infrared rays, ultrasound, or laser), may transmit a signal from a transmitter and then measure the signal by a receiver, and may measure a distance to an object based on the TOF of the signal.

According to an embodiment, the touch sensor 413 may be disposed in the second direction \textcircled{2} of the main body 410. For example, when the user wears the electronic device 401, the eyes of the user may view in the first direction \textcircled{1} of the main body. The touch sensor 413 may be implemented as a single type or a left/right separated type based on the shape of the main body 410 but is not limited thereto. For example, in a case in which the touch sensor 413 is implemented as the left/right separated type as shown in FIG. 4A, when the user wears the electronic device 401, a first touch sensor 413a may be disposed at a position corresponding to the left eye of the user in the fourth direction \textcircled{4}, and a second touch sensor 413b may be disposed at a position corresponding to the right eye of the user in the third direction \textcircled{3}.

The touch sensor 413 may recognize a touch input using at least one of, for example, capacitive, resistive, infrared, or ultrasonic method. For example, the touch sensor 413 using the capacitive method may recognize a physical touch (or contact) input or hovering (or proximity) input of an external object. According to some embodiments, the electronic device 401 may use a proximity sensor (not shown) to recognize the proximity to an external object.

According to an embodiment, the touch sensor 413 may have a two-dimensional (2D) surface and transmit, to a processor (e.g., the processor 120 of FIG. 1), touch data (e.g., touch coordinates) of an external object (e.g., a finger of the user) contacting the touch sensor 413. The touch sensor 413 may detect a hovering input of an external object (e.g., a finger of the user) approaching within a first distance away from the touch sensor 413 or detect a touch input contacting the touch sensor 413.

According to an embodiment, the touch sensor 413 may provide 2D information about the contact point to the processor 120 as “touch data” when an external object touches the touch sensor 413. The touch data may be described as a “touch mode.” When the external object is positioned within the first distance from the touch sensor 413 (or hovers above a proximity or touch sensor), the touch sensor 413 may provide hovering data about a time point or position of the external object hovering around the touch sensor 413 to the processor 120. The hovering data may also be described as a “hovering mode/proximity mode.”

According to an embodiment, the electronic device 401 may obtain the hovering data using at least one of the touch sensor 413, a proximity sensor (not shown), and/or the depth sensor 417 to generate information about a distance between the touch sensor 413 and an external object, a position, or a time point.

According to an embodiment, the main body 410 may include a processor (e.g., the processor 120 of FIG. 1) and memory (e.g., the memory 130 of FIG. 1) therein.

The memory may store various instructions that may be executed by the processor. The instructions may include control instructions, such as arithmetic and logical operations, data movement, or input/output, which may be recognized by the processor. The memory may include volatile memory (e.g., the volatile memory 132 of FIG. 1) and non-volatile memory (e.g., the non-volatile memory 134 of FIG. 1) to store, temporarily or permanently, various pieces of data.

The processor may be operatively, functionally, and/or electrically connected to each of the components of the electronic device 401 to perform control and/or communication-related computation or data processing of each of the components. The operations performed by the processor may be stored in the memory and, when executed, may be executed by the instructions that cause the processor to operate.

Although there will be no limitation to the computation and data processing functions implemented by the processor on the electronic device 401, a series of operations related to an XR content service function will be described hereinafter. The operations of the processor to be described below may be performed by executing the instructions stored in the memory.

According to an embodiment, the processor may generate a virtual object based on virtual information based on image information. The processor may output a virtual object related to an XR service along with background spatial information through the display 421. For example, the processor may obtain image information by capturing an image related to a real space corresponding to an FOV of the user wearing the electronic device 401 through the second function cameras 411 and 412 or may generate a virtual space of a virtual environment. For example, the processor may control the display 421 to display XR content (hereinafter, referred to as an XR content screen) that is output such that at least one virtual object appears overlaid in a region of a field of view (FoV) or in a region determined to be a field of view of the user.

According to an embodiment, the electronic device 401 may have a form factor to be worn on the head of the user. The electronic device 401 may further include a strap and/or a wearing member to be fixed on the body part of the user. The electronic device 401 may provide a VR, AR, and/or MR-based user experience while being worn on the head of the user.

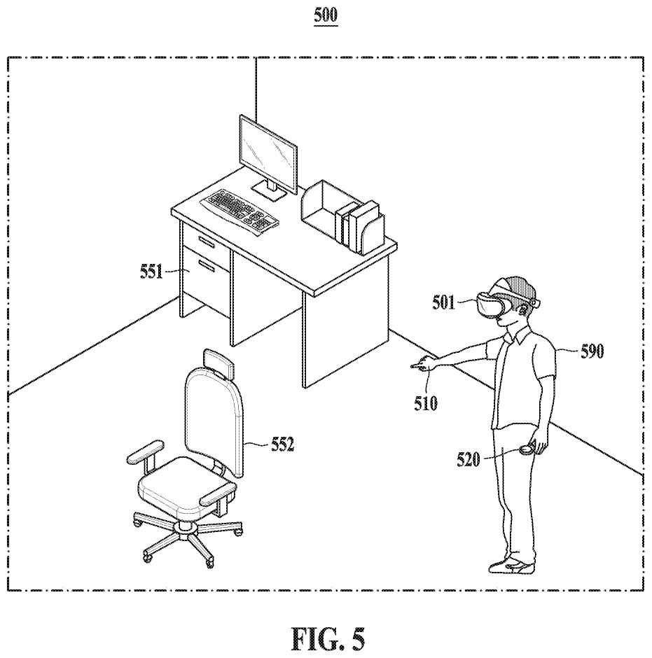

FIG. 5 illustrates an example of construction of a virtual space and an input from and an output to a user in the virtual space according to an embodiment of the disclosure.

Referring to FIG. 5, an electronic device (e.g., the electronic device 101 of FIG. 1, the electronic device 201 of FIG. 2, the electronic device 301 of FIG. 3, and the electronic device 401 of FIGS. 4A and 4B) may obtain spatial information about a physical space in which sensors are located using the sensors. The spatial information may include a geographic location of the physical space in which the sensors are located, a size of the space, an appearance of the space, a position of a physical object 551 disposed in the space, a size of the physical object 551, an appearance of the physical object 551, and illuminant information. The appearance of the space and the physical object 551 may include at least one of a shape, a texture, or a color of the space and the physical object 551. The illuminant information, which is information about a light source that emits light acting in the physical space, may include at least one of an intensity, a direction, or a color of illumination. The sensor described above may collect information to provide AR. For example, with reference to the AR device illustrated in FIGS. 2, 4A and 4B, the sensor may include a camera and a depth sensor. However, the sensors are not limited thereto, and the sensors may further include at least one of an infrared sensor, a depth sensor (e.g., a light detection and ranging (LiDAR) sensor, a radio detection and ranging (radar) sensor, or a stereo camera), a gyro sensor, an acceleration sensor, or a geomagnetic sensor.

An electronic device 501 may collect spatial information over multiple time frames. For example, in each time frame, the electronic device 501 may collect information about a space of a portion belonging to a scene within a sensing range (e.g., an FOV) of a sensor at a position of the electronic device 501 in the physical space. The electronic device 501 may analyze the spatial information of the time frames to track a change (e.g., a position movement or state change) of an object over time. The electronic device 501 may integrally analyze the spatial information collected through the plurality of sensors to obtain integrated spatial information (e.g., an image obtained by spatially stitching scenes around the electronic device 501 in the physical space) of an integrated sensing range of the plurality of sensors.

According to an embodiment, the electronic device 501 may analyze the physical space as three-dimensional (3D) information, using various input signals (e.g., sensing data of an RGB camera, an infrared sensor, a depth sensor, or a stereo camera) of the sensors. For example, the electronic device 501 may analyze at least one of the shape, the size, or the position of the physical space, and the shape, the size, or the position of the physical object 551.

For example, the electronic device 501 may detect an object captured in a scene corresponding to an FOV of a camera, using sensing data (e.g., a captured image) of the camera. The electronic device 501 may determine a label of the physical object 551 (e.g., as information indicating classification of an object, including values indicating a chair, a monitor, or a plant) from a 2D scene image of the camera and an area (e.g., a bounding box) occupied by the physical object 551 in the 2D scene. Accordingly, the electronic device 501 may obtain 2D scene information from a position at which a user 590 is viewing. In addition, the electronic device 501 may also calculate a position of the electronic device 501 in the physical space based on the sensing data of the camera.

The electronic device 501 may obtain position information of the user 590 and depth information of a real space in a viewing direction, using sensing data (e.g., depth data) of a depth sensor. The depth information may be information indicating a distance from the depth sensor to each point and may be expressed in the shape of a depth map. The electronic device 501 may analyze a distance of each pixel unit from a 3D position viewed by the user 590.

The electronic device 501 may obtain information including a 3D point cloud and a mesh using various sensing data. The electronic device 501 may obtain a plane, a mesh, or a 3D coordinate point cluster that configures a space by analyzing the physical space. The electronic device 501 may obtain a 3D point cloud representing physical objects based on the information obtained as described above.

The electronic device 501 may obtain information including at least one of 3D position coordinates, 3D shapes, or 3D sizes (e.g., 3D bounding boxes) of the physical objects arranged in the physical space by analyzing the physical space.

Accordingly, the electronic device 501 may obtain physical object information detected in the 3D space and semantic segmentation information about the 3D space. The physical object information may include at least one of a position, an appearance (e.g., a shape, texture, and color), or a size of the physical object 551 in the 3D space. The semantic segmentation information, which is information obtained by semantically segmenting the 3D space into subspaces, may include, for example, information indicating that the 3D space is segmented into an object and a background and information indicating that the background is segmented into a wall, a floor, and a ceiling. As described above, the electronic device 501 may obtain and store 3D information (e.g., spatial information) about the physical object 551 and the physical space. The electronic device 501 may store 3D position information of the user 590 in the space, along with the spatial information.

The electronic device 501 in an embodiment may build a virtual space 500 based on a physical position of the user 590 and/or the electronic device 501. The electronic device 501 may generate the virtual space 500 by referring to the spatial information described above. The electronic device 501 may generate the virtual space 500 of the same scale as the physical space based on the spatial information and arrange objects in the generated virtual space 500. The electronic device 501 may provide a complete VR to the user 590 by outputting an image that substitutes the entire physical space. The electronic device 501 may provide MR or AR by outputting an image that substitutes a portion of the physical space. Although the construction of the virtual space 500 based on the spatial information obtained by the analysis of the physical space is described, the electronic device 501 may also construct the virtual space 500 irrespective of the physical position of the user 590. Herein, the virtual space 500 may be a space corresponding to AR or VR.

For example, the electronic device 501 may provide virtual graphic representation substituting at least a partial space of the physical space. The electronic device 501 based on OST may output virtual graphic representation by overlaying the virtual graphic representation on a screen region corresponding to the at least partial space in the screen display portion. The electronic device 501 based on VST may output an image that is generated by substituting, with virtual graphic representation, an image region corresponding to at least a partial space in a spatial image that corresponds to a physical space and is rendered based on spatial information. The electronic device 501 may substitute at least a portion of a background in the physical space with a virtual graphic representation, but embodiments are not limited thereto. The electronic device 501 may only additionally arrange a virtual object 552 in the virtual space 500 based on the spatial information, without changing the background.

The electronic device 501 may arrange and output the virtual object 552 in the virtual space 500. The electronic device 501 may set a manipulation area for the virtual object 552 in a space occupied by the virtual object 552 (e.g., a volume corresponding to an appearance of the virtual object 552). The manipulation region may be a region in which a manipulation of the virtual object 552 occurs. In addition, the electronic device 501 may substitute the physical object 551 with the virtual object 552 and output the virtual object 552. The virtual object 552 corresponding to the physical object 551 may have the same or similar shape as or to the corresponding physical object 551. However, embodiments are not limited thereto, and the electronic device 501 may set only the manipulation region in a space occupied by the physical object 551 or at a position corresponding to the physical object 551, without outputting the virtual object 552 that substitutes the physical object 551. That is, the electronic device 501 may transmit, to the user 590, visual information representing the physical object 551 (e.g., light reflected from the physical object 551 or an image obtained by capturing the physical object 551) as it is without a change, and set the manipulation area in the corresponding physical object 551. The manipulation region may be set to have the same shape and volume as the space occupied by the virtual object 552 or the physical object 551, but is not limited thereto. The electronic device 501 may set the manipulation region that is smaller than the space occupied by the virtual object 552 or the space occupied by the physical object 551.

According to an embodiment, the electronic device 501 may arrange the virtual object (e.g., an avatar object) representing the user 590 in the virtual space 500. When the avatar object is provided in a first-person view, the electronic device 501 may provide a visualized graphic representation corresponding to a portion of the avatar object (e.g., a hand, a torso, or a leg) to the user 590 via the display described above (e.g., an OST display or a VST display). However, embodiments are not limited thereto, and when the avatar object is provided in a third-person view, the electronic device 501 may provide a visualized graphic representation corresponding to the entire shape (e.g., a back view) of the avatar object to the user 590 via the display described above. The electronic device 501 may provide the user 590 with an experience integrated with the avatar object.

In addition, the electronic device 501 may provide an avatar object of another user who enters the same virtual space 500. The electronic device 501 may receive feedback information that is the same as or similar to feedback information (e.g., information based on at least one of visual sensation, auditory sensation, or tactile sensation) provided to another electronic device 501 entering the same virtual space 500. For example, when an object is arranged in any virtual space 500 and a plurality of users access the virtual space 500, respective electronic devices 501 of the plurality of users 590 may receive feedback information (e.g., a graphic representation, a sound signal, or haptic feedback) of the same object arranged in the virtual space 500 and provide the feedback information to each user 590.

The electronic device 501 may detect an input to an avatar object of another electronic device 501 and may receive feedback information from the avatar object of the other electronic device 501. An exchange of inputs and feedback for each virtual space 500 may be performed by a server (e.g., the server 108 of FIG. 1). For example, the server (e.g., a server providing a metaverse space) may transfer, to the users 590, inputs and feedback between the avatar object of the user 590 and an avatar object of another user 590. However, embodiments are not limited thereto, and the electronic device 501 may establish direct communication with the other electronic device 501 to provide an input based on an avatar object or receive feedback, not via the server.

For example, based on detecting a user input that selects a manipulation region, the electronic device 501 may determine that the physical object 551 corresponding to the selected manipulation region is selected by the user 590. An input of the user 590 may include at least one of a gesture input made using a body part (e.g., a hand or eye), an input made using a separate VR accessory device, or a voice input of the user.

The gesture input may be an input corresponding to a gesture identified by tracking a body part 510 of the user 590 and may include, for example, an input indicating or selecting an object. The gesture input may include at least one of a gesture by which a body part (e.g., a hand) moves toward an object for a predetermined period or more, a gesture by which a body part (e.g., a finger, an eye, or a head) points at an object, or a gesture by which a body part and an object contact each other spatially. A gesture of pointing at an object with an eye may be identified based on ET. A gesture of pointing at an object with a head may be identified based on head tracking.

Tracking the body part 510 of the user 590 may be mainly performed based on a camera of the electronic device 501 but is not limited thereto. The electronic device 501 may track the body part 510 based on a cooperation of sensing data of a vision sensor (e.g., image data of a camera and depth data of a depth sensor) and information collected by accessory devices to be described below (e.g., controller tracking or finger tracking in a controller). Finger tracking may be performed by sensing a distance or contact between an individual finger and the controller based on a sensor (e.g., an infrared sensor) embedded in the controller.

An accessory device for VR may include a ride-on device, a wearable device, a controller device 520, or other sensor-based devices. The ride-on device may be a device that the user 590 rides and manipulates and may include, for example, at least one of a treadmill-type device or a chair-type device. The wearable device, which is a manipulation device worn on at least a part of the body of the user 590, may include, for example, at least one of a full body suit-type or a half body suit-type controller, a vest-type controller, a shoe-type controller, a bag-type controller, a glove-type controller (e.g., a haptic glove), or a face mask-type controller. The controller device 520 may include, for example, an input device (e.g., a stick-type controller or a firearm) manipulated by a hand, foot, toe, or other body parts 510.

The electronic device 501 may track at least one of a position or a movement of the accessory device by directly establishing communication with the accessory device, but the example is not limited thereto. The electronic device 501 may communicate with the accessory device via a base station for VR.

For example, the electronic device 501 may determine that the virtual object 552 is selected, based on detecting an act of gazing at the virtual object 552 for a predetermined period of time or more through eye gaze tracking technology described above. In another example, the electronic device 501 may recognize a gesture of pointing at the virtual object 552 through hand tracking technology. The electronic device 501 may determine that the virtual object 552 is selected, based on that a direction in which a tracked hand points indicates the virtual object 552 for a predetermined period or more or that a hand of the user 590 contacts or enters a region occupied by the virtual object 552 in the virtual space 500.

The voice input of the user, which is an input corresponding to a user's voice obtained by the electronic device 501, may be sensed by, for example, an input module (e.g., a microphone) of the electronic device 501 or may include voice data received from an external electronic device of the electronic device 501. By analyzing the voice input of the user, the electronic device 501 may determine that the physical object 551 or the virtual object 552 is selected. For example, based on detecting a keyword indicating at least one of the physical object 551 or the virtual object 552 from the voice input of the user, the electronic device 501 may determine that at least one of the physical object 551 or the virtual object 552 corresponding to the detected keyword is selected.

The electronic device 501 may provide feedback to be described below as a response to the input of the user 590 described above.

The feedback may include visual feedback, auditory feedback, haptic feedback, olfactory feedback, or gustatory feedback. The feedbacks may be rendered by the server 108, the electronic device 101, or the external electronic device 102 described with reference to FIG. 1.

The visual feedback may include an operation of outputting an image through the display (e.g., a transparent display or an opaque display) of the electronic device 501.

The auditory feedback may include an operation of outputting sound through a speaker of the electronic device 501.

The haptic feedback may include force feedback that simulates a weight, a shape, texture, a dimension, and dynamics. For example, the haptic glove may include a haptic element (e.g., an electric muscle) that simulates a sense of touch by tensing and relaxing the body of the user 590. The haptic element in the haptic glove may function as a tendon. The haptic glove may provide haptic feedback to the entire hand of the user 590. The electronic device 501 may provide feedback that represents a shape, a size, and stiffness of an object through the haptic glove. For example, the haptic glove may generate force that simulates a shape, a size, and stiffness of an object. The exoskeleton of the haptic glove (or a suit-type device) may include a sensor and a finger motion measurement device, may transfer cable-pulling force (e.g., an electromagnetic, direct current (DC) motor-based, or pneumatic force) to fingers of the user 590, and may thereby transmit tactile information to the body. Hardware providing haptic feedback may include a sensor, an actuator, a power, and a wireless transmission circuit. The haptic glove may operate by inflating and deflating an inflatable air bladder on a surface of the glove.

Based on an object in the virtual space 500 being selected, the electronic device 501 may provide feedback to the user 590. For example, the electronic device 501 may output a graphic representation (e.g., a representation of highlighting the selected object) indicating the selected object through the display. For example, the electronic device 501 may output a sound (e.g., a voice) notifying the selected object through a speaker. In another example, the electronic device 501 may transmit an electrical signal to a haptic supporting accessory device (e.g., the haptic glove) and may thereby provide a haptic motion that simulates a tactile sensation of a corresponding object to the user 590.

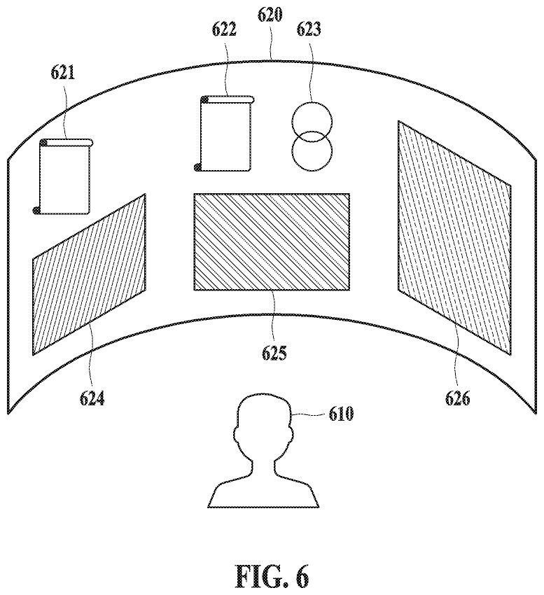

FIG. 6 illustrates an example of an operation in which an electronic device provides a space to a user according to an embodiment of the disclosure.

Referring to FIG. 6, an electronic device (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5), according to an embodiment, may display an image obtained by rendering objects 621, 622, 623, 624, 625, and 626 disposed in the space. The space according to an embodiment may include at least one of a physical space or a virtual space.

For example, the space may include a virtual space constructed based on a physical space. For example, the electronic device may obtain spatial information about the physical space around the electronic device, and construct and provide a virtual space based on a property (e.g., scale) of the obtained physical space. In various embodiments of the disclosure, a space including the virtual space constructed based on the physical space around the electronic device may also be represented as a video see-through (VST) space.

For example, the space may include a virtual space constructed independently of the physical space around the electronic device. For example, the space may be a virtual space constructed based on a physical space different from the physical space around the electronic device. For example, the space may be a virtual space constructed by a server (e.g., the server 108 of FIG. 1). In various embodiments of the disclosure, a space including the virtual space constructed independently of the physical space around the electronic device may also be represented as a virtual reality (VR) space.

For example, the space may include a physical space around the electronic device and a virtual space in which a virtual object is disposed. The virtual space in which the virtual object is disposed may be constructed based on the physical space around the electronic device. In other words, the space may include a combined space of the physical space around the electronic device and the virtual space in which the virtual object is disposed. For example, when the electronic device is an OST-based electronic device (e.g., the electronic device 201 of FIG. 2), at least a portion of the physical space around the electronic device may be directly recognized by a user 610 through a transparent member, and at least a portion of the virtual space may be displayed with an element (e.g., a visual effect or a virtual object) of the virtual space on a display to provide the virtual space to the user 610. In other words, light from the outside (e.g., a background of the physical space around the electronic device or a physical object) reaches eyes of the user 610 through a transparent member, so that the user 610 may recognize the physical space around the user 610, and may recognize a virtual space overlaid on the physical space around the user 610 by displaying elements of the virtual space through the display. For example, the electronic device may provide the user 610 with a space in which the elements of the virtual space are additionally disposed against the background of the physical space around the user 610. In various embodiments of the disclosure, the space including the physical space around the electronic device and the virtual space may also be represented as an OST space or an AR space.

An object disposed in the space may include a physical object and a virtual object.

For example, the virtual object may include a virtual object for executing an application (e.g., an application icon), a virtual object that provides information (e.g., a virtual object displaying weather information or a virtual object displaying a memo), and a virtual object including an execution screen of an application (e.g., a window displaying the execution screen of the application). The virtual object may include, for example, a widget, an icon, a visualization anchor, or an execution screen of an application (or a window displaying an execution screen).

For example, the virtual object may be related to a physical object. The virtual object based on the physical object may include a virtual object that replaces the physical object and/or a virtual object related to the physical object (e.g., a virtual controller for controlling the physical object).

Referring to FIG. 6, the electronic device may display a screen 620 of a space when the user 610 wearing the electronic device enters the space. The electronic device may determine a subspace to be displayed to the user 610 from the space based on gaze of the user 610, and may display the screen 620 based on rendered data obtained by rendering objects 621, 622, 623, 624, 625, and 626 disposed in the subspace. FIG. 6 illustrates that the objects 621, 622, 623, 624, 625, and 626 are disposed on a curved surface area on the screen 620, but embodiments are not limited thereto, and the objects may be disposed on a surface other than the curved surface area.

According to an embodiment, the electronic device may obtain information about a viewpoint of the user 610 wearing the electronic device (e.g., the user's perspective). The electronic device may display the screen 620 of a space corresponding to a viewpoint based on information about the viewpoint of the user 610.

In the remaining portion of the screen 620 of FIG. 6 other than the objects 621, 622, 623, 624, 625, and 626, at least a portion of the background of the space may be displayed. For example, when the space is a VST space, the remaining portion of the screen other than the objects 621, 622, 623, 624, 625, and 626 may display a virtual space in which the physical space around the electronic device is reconstructed. For example, when the space is an AR space, the remaining portion of the screen other than the objects 621, 622, 623, 624, 625, and 626 may be display the physical space around the electronic device. For example, when the space is a VR space, the remaining portion of the screen other than the objects 621, 622, 623, 624, 625, and 626 may be displayed as a virtual space (e.g., a virtual space built independently of the surroundings of the electronic device).

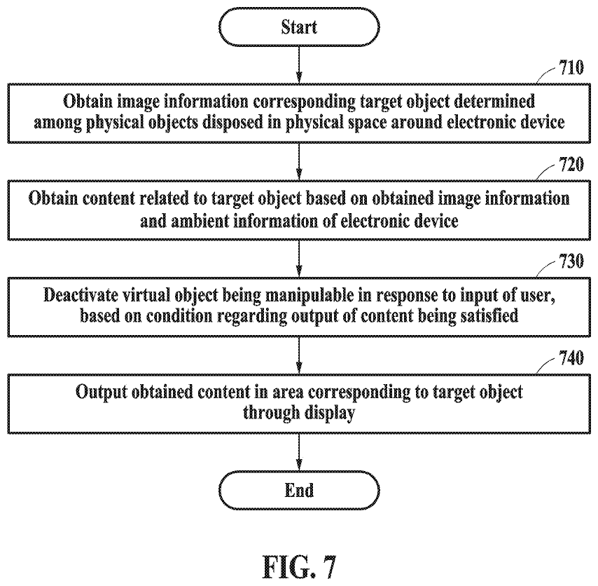

FIG. 7 is a flowchart illustrating an example of a method of outputting content related to a target object by an electronic device according to an embodiment of the disclosure.

Referring to FIG. 7, an electronic device (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5) according to an embodiment may provide a user with a space (e.g., a VST space or an AR space) based on the physical space around the electronic device.

The electronic device may operate in one of a plurality of operation modes. For example, the plurality of operation modes of the electronic device may include a first operation mode (e.g., a normal operation mode) and a second operation mode (e.g., a relaxation operation mode). The electronic device may display and activate an interaction object while the operation mode of the electronic device is the first operation mode. The electronic device may deactivate the interaction object and output content to alleviate user fatigue while the electronic device is the second operation mode (e.g., the relaxation operation mode). As will be described below, the transition between the first operation mode and the second operation mode may be performed based on conditions.

In operation 710, the electronic device may obtain image information corresponding to a target object determined (e.g., selected or identified) among physical objects disposed in a physical space around the electronic device. The electronic device may select the target object from among objects disposed in a space provided to a user.

According to an embodiment, the electronic device may obtain background information about an external environment (e.g., a physical space around the electronic device) that is sensed by a sensor (e.g., a camera sensor) of the electronic device. The electronic device may analyze the background information and select at least one object requiring a movement as the target object. According to an embodiment, when the at least one object requiring a movement is determined as an object capable of providing a sense of vitality in a real environment, a movable object, or an object, to which at least one interactive animation (or effect) is applicable, the object may be selected as the target object.

According to an embodiment, the electronic device may obtain image information about the physical space around the electronic device. The electronic device may detect physical objects disposed in the physical space. For example, the electronic device may calculate a score for each of the physical objects regarding the generation of content based on the corresponding physical object. The electronic device may determine a physical object having a highest score (or physical objects having the highest scores) among the physical objects as the target object.

According to an embodiment, the space provided to the user may be a space based on the physical space around the electronic device. For example, the space may include a virtual space (e.g., a VST space) constructed based on the physical space around the electronic device. For example, the space may include a space (e.g., an AR space) that combines the physical space around the electronic device and the virtual space in which the virtual objects are disposed.

According to an embodiment, the electronic device may select the target object among physical objects disposed in the physical space around the electronic device (or the user). The target object is an object selected from among the physical objects and may refer to an object that is a target of content to be obtained (e.g., a video, an image, or the like). As will be described below, the electronic device may obtain a video of a target object with motion.

For example, the electronic device may select an object movable according to a surrounding environment, among the physical objects, as the target object. The electronic device may, for example, select, as the target object, an object that may be swayed (e.g., a plant pot, flag, or pinwheel) when wind blows in the physical space around the electronic device among physical objects.

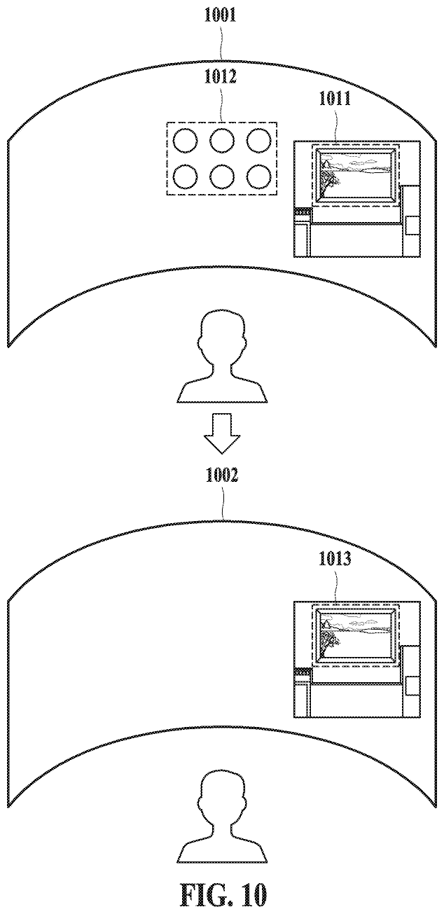

However, the electronic device according to various embodiments of the disclosure is not limited to selecting a movable physical object as the target object. As will be described below with reference to FIG. 10, the target object may be selected as a physical object that displays a scene within an internal area of the target object.

According to an embodiment, the image information corresponding to the target object may include an image obtained by capturing the target object. The electronic device may obtain the image obtained by capturing the selected target object. For example, the electronic device may obtain the image obtained by capturing the target object based on a sensor (e.g., a camera sensor or a depth sensor) mounted on the electronic device. For example, the electronic device may obtain the image obtained by capturing the target object by segmenting an area corresponding to the target object within an image of a space (e.g., a stereoscopic image).

According to an embodiment, the electronic device may determine (e.g., select) the target object and then obtain the image information corresponding to the target object. According to an embodiment, the electronic device may obtain image information about the physical space around the electronic device. The electronic device may select the target object by analyzing the image information about the physical space. The electronic device may segment (e.g., crop) a portion of the area corresponding to the target object from the image of the physical space.

In operation 720, the electronic device may obtain content related to the target object (e.g., a video of the target object moving) based on the obtained image information and ambient information of the electronic device.

According to an embodiment, the ambient information of the electronic device may include environmental information about the physical space around the electronic device. For example, the ambient information of the electronic device may include weather information and/or time information of the physical space around the electronic device.

The weather information may be information about the weather in a geographic area around the electronic device. For example, the weather information may include at least one of temperature information, rain information, wind information, fine dust information, or humidity information.

The time information may be information about the time of the geographical area around the electronic device. For example, the time information may include at least one of season information, date information, or standard time information of the geographical area around the electronic device.

According to an embodiment, the electronic device may obtain the content related to the target object based on the image information obtained by capturing the target object and the ambient information. For example, the content related to the target object may include a video of the target object moving and/or other images of the target object. For example, the content may obtain content (e.g., an image or a video) that may be displayed within the internal area of the target object.

According to an embodiment, when the content includes a video, the video may include a plurality of frame images of the target object. The video may include a result of applying a movement based on an environment corresponding to the ambient information to the target object shown in the image information. For example, when the target object is a plant pot and the ambient information includes wind blowing in the geographical area around the electronic device, the video may include the plant pot shaking due to the wind.

According to an embodiment, when the content includes an image, the image may include at least one visual property of the target object modified. The visual property may include a color, shape, size, and/or texture.

In various embodiments of the disclosure, the content obtained based on the target object is not limited to a single piece of content. According to an embodiment, the electronic device may obtain a plurality of content (or a plurality of content related to the target object) based on the target object.

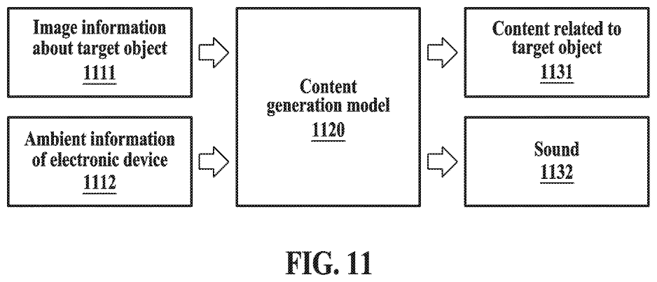

According to an embodiment, the electronic device may obtain an additional object using a content generation model. The content generation model is described in more detail below with reference to FIG. 11.

In operation 730, the electronic device may deactivate an interaction object being manipulable in response to an input of a user, based on a condition regarding an output of the content being satisfied.

According to an embodiment, the condition regarding the output of the content may include a condition regarding the input of the user indicating that a user's intent is expected not to perform manipulation on the electronic device for a given period of time. According to an embodiment, the condition regarding the output of the content may be a condition corresponding to the transition of the operation mode of the electronic device from the first operation mode (e.g., the normal operation mode) to the second operation mode (e.g., the relaxation operation mode).

For example, the condition regarding the output of the content may include at least one of gaze of the user not pointing at the interaction object for a threshold time, biometric information of the user satisfying a predetermined condition, or no input of the user triggering an operation of the electronic device being detected from the user for a threshold time.

The gaze of the user not pointing at the interaction object for a threshold time may include the interaction object selected based on the gaze of the user does not exist during the threshold time. For example, the electronic device according to an embodiment may detect that the interaction object is pointed by the gaze of the user when the overlap between a pointer area based on the gaze of the user and an area corresponding to the interaction object is maintained for a specific amount of time or longer.

The biometric information of the user may be determined based on sensing data obtained through a biometric sensor. For example, the biometric information may include heart rate information, blood pressure information, electrocardiogram (ECG) information, and/or stress information. For example, a condition regarding each of examples of the biometric information of the user or a combination of two or more examples of the biometric information of the user (e.g., a condition corresponding to the transition from the normal operation mode to a relaxation operation mode) may be predetermined. The electronic device may monitor at least one piece of the biometric information. The electronic device may change the operation mode of the electronic device from the first operation mode to the second operation mode based on the at least one of the biometric information satisfying a predetermined condition.

The input of the user triggering the operation of the electronic device may include, for example, an input of the user for the interaction object that may be manipulated in response to the input of the user. The interaction object that may be manipulated in response to input of the user is described in more detail below.

However, in various embodiments of the disclosure, the condition regarding the output of the content (or the condition corresponding to the transition from the first operation mode to the second operation mode) is not limited to the examples described above. For example, when the user is expected not to perform any manipulation on the electronic device for a given period of time based on a result of tracking the gaze of the user (e.g., when the user is expected not to focus on the provided space), the electronic device may change the operation mode from the first operation mode to the second operation mode.

For example, the electronic device may obtain a saliency map based on the result of tracking the gaze of the user. The saliency map may indicate a point, where the user focuses, in an image corresponding to the space provided to the user. For example, the electronic device may change the operation mode of the electronic device from the first operation mode to the second operation mode based on a degree of matching between the interaction object and the saliency map obtained based on eye tracking of the user (e.g., when a score indicating the degree of matching is less than a threshold score).

According to an embodiment, the condition regarding the output of the content (e.g., display of an image or playback of a video) may include obtaining an input corresponding to the output of the content (e.g., a content output input or a trigger input for the relaxation operation mode). For example, the input of the user (e.g., a trigger input for the relaxation operation mode) may include at least one of a button input, a motion input, a gesture input, or a voice input.

The button input may refer to an input detected through a physical button included in the electronic device or an external device (e.g., the input module 150 of FIG. 1 or the controller device 520 of FIG. 5) that is communicatively connected to the electronic device. For example, the electronic device or the external device may include a button assigned to a function of changing the operation mode of the electronic device to the relaxation operation mode, and may detect the trigger input of the relaxation operation mode when detecting that a corresponding button is pressed.

The motion input may refer to a motion applied to the electronic device or the external device (e.g., the input module 150 of FIG. 1 or the controller device 520 of FIG. 5) that is communicatively connected to the electronic device. The motion input may include an input detected when the user rotates, tilts, and/or moves the electronic device or the external device. For example, a specific motion may be assigned to the function of changing the operation mode of the electronic device to a relaxation operation mode, and the trigger input of the relaxation operation mode may be detected when the electronic device or the external device detects that the specific motion occurs. For example, the specific motion may be determined as a motion that moves along at least a portion of a determined movement trajectory (e.g., a circle, a closed curve, or a check mark (e.g., a V mark)).

The gesture input may refer to an input corresponding to a gesture identified based on tracking the body part (e.g., a finger, an eye, or a head) of the user. The gesture input may include a gesture input corresponding to a gesture of pointing and/or dragging an object with the body part of the user. For example, a specific gesture may be assigned to the function of changing the operation mode of the electronic device to the relaxation operation mode, and the trigger input for the relaxation operation mode may be detected when the electronic device or the external device detects that the specific gesture occurs. For example, the specific gesture may be determined as a gesture of pointing to the area corresponding to the interaction object with the eyes of the user and/or gripping the area corresponding to the interaction object with the hand.

The voice input may refer to an input corresponding to a voice of the user obtained through the electronic device or the external device that is communicatively connected to the electronic device. The electronic device may analyze the voice input to determine that the voice input of the user requests to change the operation mode of the electronic device to the relaxation operation mode. When the user's intent identified based on the voice input of the user is to change the operation mode of the electronic device to the relaxation operation mode, the electronic device may obtain the voice input as the trigger input for the relaxation operation mode.

According to an embodiment, the electronic device may obtain voice data corresponding to the voice of the user. The electronic device may analyze the voice data using a natural language platform. For example, the natural language platform may include an automatic speech recognition (ASR) module and/or a natural language understanding (NLU) module.

For example, the ASR module may convert the voice input of the user into text data. The NLU module may use the text data of the voice input to identify the intent of the user. For example, the NLU module may perform syntactic analysis or semantic analysis to identify the intent of the user. In an embodiment, the NLU module may use linguistic features (e.g., grammatical elements) of morphemes or phrases to identify the meaning of words extracted from the voice input and to determine the intent of the user by matching the meaning of the identified words to the intent.

The input of the user (e.g., the trigger input for the relaxation operation mode) is not limited to including one of a button input, a motion input, a gesture input, or a voice input and may be an input of the user in which two or more of the button input, the motion input, the gesture input, the voice input, or the biometric signal input are combined. The input of the user in which two or more of the button input, the motion input, the gesture input, the voice input or the biometric signal input are combined may also be represented as a “multimodal input.”

The electronic device may deactivate the interactive object that may be manipulated in response to input of the user when the condition regarding the output of the content (e.g., display of an image or playback of a video) is satisfied. The interaction object that may be manipulated in response to input of the user may refer to an interaction object to which a specific operation of the electronic device is assigned. In various embodiments of the disclosure, the interaction object that may be manipulated in response to the input of the user may also be represented as an interaction object.

For example, the interaction object may include an icon object corresponding to an application. An execution operation of a corresponding application and/or a display operation of an execution screen of the application may be assigned to the icon object. For example, the interaction object may include a widget object. An update operation of corresponding information and/or a display operation of an execution screen of a corresponding application may be assigned to the widget object.

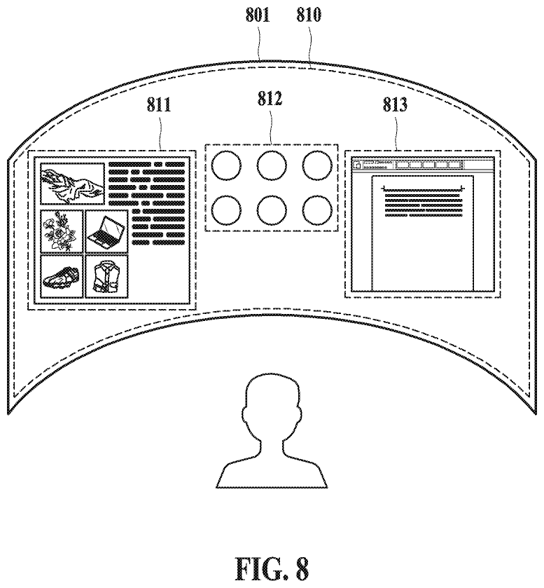

For example, the interaction object may include a button object and/or a controller object including two or more button objects. The button object (or the controller object) may have a specific operation assigned to the button object (or the controller object). The electronic device may perform an operation assigned to the button object (or the controller object) based on an input of the user obtained through the button object (or the controller object). The example of the interaction object is described in more detail below with reference to FIG. 8.

The deactivation of the interaction object may include at least partially restricting the display of the interaction object. For example, the electronic device may include not displaying the interaction object. However, the deactivation of the interaction objects is not limited thereto.

For example, the deactivation of the interaction object may include displaying the interaction object with a predetermined visual property (e.g., transparency more than or equal to threshold transparency or brightness less than threshold brightness). The deactivation of the interaction object may include ignoring the input of the user detected through the interaction object. For example, the electronic device may restrict the performance of the operation of the electronic device assigned to the interaction object even if the input of the user of selecting the interaction object is detected.

In various embodiments of the disclosure, the deactivation of the interaction object may refer to deactivating the visual property of the interaction object, and may be independent of the stopping of the operation related to the interaction object (e.g., execution of an application corresponding to the interaction object). For example, the interaction object may correspond to a controller regarding the playback of music. The electronic device may deactivate the interaction object (e.g., restrict the display) and maintain the playback of music based on the condition regarding the output of the content being satisfied.

In various embodiments of the disclosure, the electronic device is not limited to deactivating all interaction objects when the condition regarding the output of the content is satisfied. According to an embodiment, the electronic device may determine the deactivation of the interaction object based on a position where the interaction object is aligned. The interaction object may be disposed within a space including the virtual object and the background based on the physical space around the electronic device. For example, the interaction object may be disposed at a position aligned according to the background based on the physical space around the electronic device, or disposed at a position aligned according to the electronic device within the space.

When the interaction object is disposed in a position aligned according to the background, it may be provided in a form attached to a specific position in the physical space around the electronic device. The electronic device may maintain the display of the interaction object based on the interaction object being disposed in a position aligned according to the background.

When the interaction object is disposed in a position aligned according to the electronic device (e.g., a pose of the electronic device, a position of the electronic device, a heading direction of the electronic device) in the space, the interaction object may be provided while maintaining a relative position to the electronic device, independently of the movement of the electronic device in the space. For example, when the interaction object is disposed in a position aligned according to the electronic device in the space, the interaction object may be provided in the form of a floating object that maintains the display at a specific position within an area of the FoV of the user. The electronic device may restrict the display of the interaction object based on the interaction object being disposed in a position aligned according to the electronic device in the space.

According to an embodiment, the interaction object disposed in a position aligned according to the background may be recognized by the user as a virtual object combined with (e.g., attached to) the physical space, and therefore, the fatigue caused to the user may be relatively less than that caused by the interaction object disposed in a position aligned according to the electronic device. The electronic device may maintain the display of the interaction object disposed in a position aligned according to the background and restrict the display of the interaction object disposed in a position aligned according to the electronic device, thereby effectively alleviate the fatigue that may be caused to the user while minimizing a difference between screens provided in the operation modes.

In operation 740, the electronic device may output the content related to the target object (e.g., play a video or display an image) in the area corresponding to the target object through a display.

According to an embodiment, the electronic device may display the content instead of the target object. For example, when the electronic device provides an AR space to the user, it may overlay the content corresponding to the target object in the area corresponding to the target object. For example, when the electronic device provides a VST space to the user, it may replace the area corresponding to the target object within an image of the VST space with the content of the target object.

According to an embodiment, the area corresponding to the target object may be determined based on the position of the target object. For example, the electronic device may determine a reference point of the target object (e.g., a center point of the target object or a feature point of the target object), and determine the area corresponding to the target object based on the reference point of the target object. For example, the electronic device may obtain the area corresponding to the target object using a content generation model (e.g., a content generation model 1120 of FIG. 11). For example, output data of the content generation model may include information about the area corresponding to the target object. The area corresponding to the target object may be determined based on information about the target object (e.g., image information corresponding to the target object).

According to an embodiment, the area corresponding to the target object may be determined as an area that may be affected by the target object. For example, when the target object is a movable object, the area corresponding to the target object may be determined based on a range of the movement of the target object. For example, when the target object may cause a change to a visual property of an area other than the target object, the area corresponding to the target object may be determined based on the area where the visual property is caused to change by the target object. For example, when the target object is a light bulb, an area reached by light emitted by the light bulb may be determined as the area corresponding to the target object. When the target object is a fan, an area where, an air flow due to wind generated by the fan exists, may be determined as the area corresponding to the target object.

For example, the area corresponding to the target object may be determined as an area where the target object is visible. The area where the target object is visible may refer to an area where the target object is visible in a display area of the display of the electronic device.

For example, the area corresponding to the target object may include the area where the target object is visible, and may be determined as an area wider than the area where the target object is visible (e.g., an area covering the area where the target object is visible).

For example, the area corresponding to the target object may be determined as a partial area of the area where the target object is visible.

For example, the area corresponding to the target object may be determined as an area including a partial area of the area, where the target object is visible, and a partial area, where the target object is not visible (e.g., an area that partially overlaps with the area where the target object is visible).

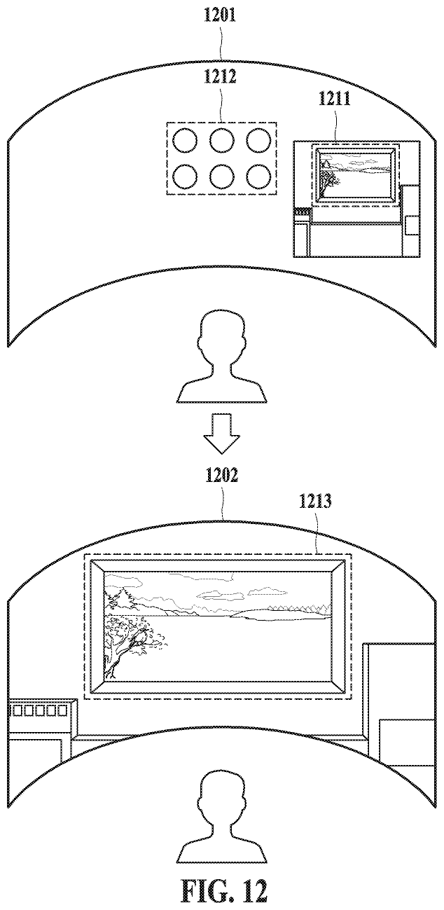

However, in various embodiments of the disclosure, the electronic device is not limited to displaying the content only in the area corresponding to the target object. According to an embodiment, the electronic device may display the content in an area larger than the area corresponding to the target object. The electronic device displaying the content in the area larger than the area corresponding to the target object is described in more detail below with reference to FIG. 12.

According to an embodiment, the electronic device may stop the output of the content based on a condition regarding stopping the output of the content being satisfied. The electronic device may activate an interaction object that may be manipulated in response to an input of the user.

The condition regarding the stopping of the output of the content may include a condition regarding the input of the user indicating that the user's intent is expected to perform the manipulation on the electronic device. According to an embodiment, the condition regarding the stopping of the output of the content may be a condition corresponding to the transition of the operation mode of the electronic device from the second operation mode (e.g., the relaxation operation mode) to the first operation mode (e.g., the normal operation mode).

The condition regarding the stopping of the output of the content (e.g., a condition for stopping the display of an image or a condition for stopping the playback of a video) may be determined based on detecting the input of the user corresponding to the stopping of the output of the content (e.g., the transition from the second operation mode to the first operation mode). It may include obtaining the input of the user corresponding to the stopping of the output of the content (e.g., an input for stopping the output of the content or an input for stopping the relaxation operation mode).

For example, the input of the user (e.g., an input for stopping the relaxation operation mode) may include at least one of a button input, a motion input, a gesture input, or a voice input.

For example, it may include a button assigned to a function of changing the operation mode of the electronic device from the relaxation operation mode to the normal operation mode, and when the button being pressed is detected, an input for stopping the relaxation operation mode may be detected.

For example, the specific motion may be assigned to the function of changing the operation mode of the electronic device from the relaxation operation mode to the normal operation mode, and when the occurrence of the specific motion is detected from the electronic device or the external device, an input for stopping the relaxation operation mode may be detected.

For example, a specific gesture may be assigned to a function of changing the operation mode of the electronic device from the relaxation operation mode to the normal operation mode, and when the occurrence of the specific gesture is detected from the electronic device or the external device, an input for stopping the relaxation operation mode may be detected.

For example, when the user's intent identified based on a voice input of the user is to change the operation mode of the electronic device from the relaxation operation mode to the normal operation mode, the electronic device may obtain the voice input as the input for stopping the relaxation operation mode.

For example, the condition regarding the stopping of the output of the content may include a condition based on an object or a sound detected in the physical space around the electronic device. For example, the condition regarding the stopping of the output of the content may include at least one of a physical object accessing a physical space within a threshold distance from the electronic device or a sound (e.g., a preset alarm) being detecting in the physical space around the electronic device.

For example, the condition regarding the stopping of the output of the content may include the occurrence of a predetermined event. The predetermined event may include an event having a priority equal to or higher than a threshold priority. The priority of an event may be preset based on properties of the event or set by the user. For example, the predetermined event may include a phone reception event and/or an alarm event.

According to an embodiment, the electronic device may control the content and the interaction object based on the transition between the operation modes of the electronic device.

The electronic device may change the operation mode of the electronic device from the first operation mode to the second operation mode based on a condition corresponding to the transition from the first operation mode to the second operation mode being satisfied when the operation mode of the electronic device is the first operation mode. The electronic device may perform the output of the content and the deactivation of the interaction object while the operation mode of the electronic device is the second operation mode. The electronic device may change the operation mode of the electronic device from the second operation mode to the first operation mode based on a condition corresponding to the transition from the second operation mode to the first operation mode being satisfied when the operation mode of the electronic device is the second operation mode. The electronic device may restrict the output of the content in the area corresponding to the target object and activate the interaction object while the operation mode of the electronic device is the first operation mode.

In various embodiments of the disclosure, it is mainly described that the electronic device performs the operation of determining whether the condition regarding the output of the content is satisfied, the operation of deactivating the interaction object, and/or the operation of outputting the content (e.g., operations 730 and 740) after the operation of determining the target object (e.g., operation 710) and/or the operation of obtaining the content (e.g., operation 720), however, embodiments are not limited thereto. According to an embodiment, the electronic device may determine whether the condition regarding the output of the content is satisfied, when the condition regarding the output of content is satisfied, perform the operation of determining the target object (e.g., operation 710) and/or the operation of obtaining the content (e.g., operation 720), and then perform the operation of deactivating the interaction object and/or the operation of outputting the content (e.g., operations 730 and 740).

FIG. 8 illustrates an example of an operation in which an electronic device provides a stereoscopic image of a space according to an embodiment of the disclosure.

Referring to FIG. 8, an electronic device (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5) according to an embodiment may provide a user with a space 801 (e.g., a VST space or an AR space) based on a physical space around the electronic device.

According to an embodiment, the electronic device may display a stereoscopic image of the space 801 including a background 810 based on the physical space around the electronic device and a virtual object through a display.

The space 801 provided to the user may include a background 810 based on a physical space and a virtual object disposed within the space 801. The background 810 based on the physical space may be a virtual space constructed based on the physical space, or may refer to at least a portion of the physical space.

An interaction object may include at least one of a window object 811 including a web page screen, an icon object 812 (or a widget object) corresponding to an application, or a window object 813 including an execution screen of an application that processes a document of a specific format (e.g., Word, PowerPoint, or Excel).

The electronic device may display a stereoscopic image of the space 801 through at least one display. The stereoscopic image may include a pair of images including a left image corresponding to the user's left eye and a right image corresponding to the user's right eye. The pair of images included in the stereoscopic image may include a pair of images reflecting binocular disparity corresponding to depth information of each point (or object) of the image. In various embodiments of the disclosure, the stereoscopic image may also be represented as a three-dimensional image and/or a space image.

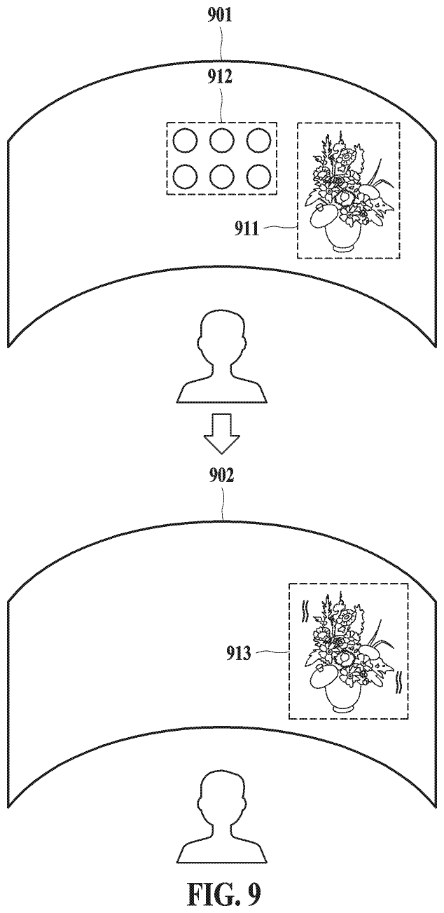

FIG. 9 is a diagram illustrating an example of an operation in which an operation mode of an electronic device transitions between a normal operation mode and a relaxation operation mode when a target object is a movable object, according to an embodiment of the disclosure.

Referring to FIG. 9, an electronic device (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5) according to an embodiment may perform deactivation of an interaction object 912 and output of content 913 of a target object 911 when the operation mode of the electronic device transitions from the normal operation mode to the relaxation operation mode. According to an embodiment, if the content 913 is a video, the electronic device may play the video.

In a normal operation mode 901, the electronic device may provide the target object 911 disposed in a physical space to the user as is, and activate (e.g., display) the interaction object 912 disposed in the space.

Providing the target object 911 disposed in the physical space to the user as is may imply that the electronic device is restricted from generating a movement of the target object 911. When the target object 911 disposed in the physical space is static, the user may recognize the target object 911 as static, and when the target object 911 disposed in the physical space has a specific motion, the user may recognize the target object 911 having a specific motion as is.

For example, when the electronic device is an OST-based electronic device (or when the space is an AR space), providing the target object 911 disposed in the physical space to the user may imply that the target object 911 disposed in the physical space is directly recognized by the user through a transparent member.

For example, when the electronic device is a VST-based electronic device (or when the space is a VST space), providing the target object 911 disposed in the physical space to the user may refer to displaying a real-time image of the target object 911 disposed in the physical space.

The electronic device may select a movable object from among physical objects disposed in the physical space around the electronic device as the target object 911. For example, in FIG. 9, the target object 911 may be selected as a plant pot disposed in the physical space.

The electronic device may change the operation mode of the electronic device from the normal operation mode 901 to a relaxation operation mode 902 based on a condition regarding the output of content (e.g., a condition corresponding to the transition from the normal operation mode 901 to the relaxation operation mode 902) being satisfied.

In the relaxation operation mode 902, the electronic device may deactivate the interaction object 912 and output the content 913 of the target object 911 in an area corresponding to the target object 911. In FIG. 9, for example, the content 913 may include a video showing a plant in a flowerpot swaying in the wind.

FIG. 10 is a diagram illustrating an example of an operation in which an operation mode of an electronic device transitions between a normal operation mode and a relaxation operation mode when displaying a scene in an internal area of a target object, according to an embodiment of the disclosure.

Referring to FIG. 10, an electronic device (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5) according to an embodiment may perform deactivation of an interaction object and output of content of a target object when the operation mode of the electronic device transitions from the normal operation mode to the relaxation operation mode.

According to an embodiment, the electronic device may select a target object as a physical object capable of displaying a scene in an internal area of the target object. For example, the target object may include at least one of a door, a picture frame, a poster, a physical window, a photograph, a picture, or other electronic devices including a display area (e.g., a television (TV), a tablet, or a smartphone).

In FIG. 10, in a normal operation mode 1001, the electronic device may provide the user with a space including an interaction object 1012 and a target object, a poster 1011. For example, the poster 1011 may include a picture of a waterfall.

According to an embodiment, the electronic device may obtain image information corresponding to a target object, and may obtain content including a video in which at least a portion of the target object moves based on the image information and ambient information.

When the target object displays a scene within the internal area of the target object, the electronic device may obtain content for the scene included in the target object. The content for the scene may include a video and/or an image in which motions of objects included in the scene and/or visual properties (e.g., a color, a texture, or a style) of the objects included in the scene are changed while maintaining semantic information of the objects included in the scene.

For example, the electronic device may obtain the image information including the scene based on displaying the scene within the internal area of the target object. The image information including the scene may include an image corresponding to the poster 1011. The electronic device may obtain the ambient information including at least one of weather information or time information about a surrounding environment of the electronic device. Based on the image information and the ambient information, the electronic device may obtain the content related to the scene with a visual property corresponding to weather or time indicated by the ambient information.

For example, when the ambient information of the electronic device indicates raining, the electronic device may obtain content about a waterfall in rainy weather. For example, when the ambient information of the electronic device indicates that it is sunny, the electronic device may obtain content about a waterfall in sunny weather. For example, when the ambient information of the electronic device indicates a time corresponding to sunset, the electronic device may obtain content about a waterfall at sunset.

The electronic device according to an embodiment may obtain the content for the scene of the target object using a content generation model. The content generation model is described in more detail below with reference to FIG. 11.

The electronic device may change the operation mode of the electronic device from the normal operation mode 1001 to a relaxation operation mode 1002 based on a condition regarding the output of content (e.g., a condition corresponding to the transition from the normal operation mode 1001 to the relaxation operation mode 1002) being satisfied.

The electronic device may output content in the internal area of the target object. In the relaxation operation mode 1002, the electronic device may deactivate the interaction object 1012 and output content 1013 of the target object (i.e., poster 1011) in an area corresponding to the target object (i.e., poster 1011). In FIG. 10, for example, the content 1013 may include a video showing a waterfall falling.

According to an embodiment, when the target object is determined as an object capable of displaying a scene in the internal area of the target object, the electronic device may output preceding content regarding a variation of the target object and subsequently output content related to the target object. The preceding content may include a video showing the shape of the target object changing.

For example, when the target object is a physical window, the preceding content may include a video showing a state of the physical window changing from a closed state to an open state. The electronic device may output the preceding content showing that the state of the physical window determined as the target object changes from the closed state to the open state, and then output content for the scene in an area corresponding to an internal area of the physical window in the open state.

For example, when the target object is a door, the preceding content may include a video showing a state of the door changing from a closed state to an open state. The electronic device may output the preceding content showing that the state of the door determined as the target object changes from the closed state to the open state, and then output content for the scene in an area corresponding to an internal area of the door in the open state.

According to an embodiment, content may be generated based on context information of the user. The context information of the user may include information about a place (e.g., a travel destination), landscape, an entity, and/or people (e.g., artists) registered by the user. For example, the context information of the user may be determined based on information shown in images included in a user terminal (e.g., an electronic device). For example, the content may include a result of reconstructing the surrounding landscape (e.g., mountains, lakes, or golf courses viewed from a location of a user) based on location information of the electronic device.

FIG. 11 is a diagram illustrating an example of an operation in which an electronic device obtains content based on a content generation model according to an embodiment of the disclosure.

Referring to FIG. 11, an electronic device (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5) according to an embodiment may obtain content 1131 of a target object using the content generation model 1120. For example, the content 1131 of the target object may include a video of the target object moving and/or a video related to a scene contained within the internal area of the target object. For example, the content 1131 of the target object may include an image in which at least a portion of the target object is deformed and/or an image in which at least a portion of a scene contained in the internal area of the target object is deformed.

The content generation model 1120 may refer to a model that is generate and/or trained to output output data including information about the content 1131 of the target object by applying to input data including information about the target object (e.g., image information 1111 about a target object) and information about a surrounding environment (e.g., ambient information 1112 of an electronic device). The content generation model 1120 may include a model based on a machine learning model (e.g., a neural network, a large language model (LLM), or a generative artificial intelligence).

The input data of the content generation model 1120 according to an embodiment is not limited to including the image information 1111 about the target object and the ambient information 1112 of the electronic device. For example, the input data of the content generation model 1120 may further include additional information about the target object. The additional information about the target object may refer to other information about the target object. For example, the additional information about the target object may include at least one of a type, class, or state (or mode) of the target object. The electronic device may obtain the additional information about the target object by analyzing an image of the target object. When the target object includes another electronic device, the electronic device may receive information about the target object through communication from the other electronic device that is the target object.

The content generation model 1120 may be stored inside the electronic device or on an external device (e.g., another electronic device, a server, or a cloud) accessible by the electronic device. The content of the target object may be generated using the content generation model 1120. For example, the electronic device may directly generate content of a target object using the content generation model 1120 (e.g., on-device), or the electronic device may transmit information about the target object (e.g., image information 1111 about the target object) and information about the surrounding environment (e.g., ambient information 1112 of the electronic device) to another electronic device storing the content generation model 1120 and receive information about the generated content 1131 of the target object (e.g., on-cloud).

According to various embodiments of the disclosure, it is mainly described that the content 1131 of the target object is generated by a generation model (e.g., the content generation model 1120), but embodiments are not limited thereto. A generation model according to an embodiment may be used to output information about a movement (or a motion) of a target object based on information about the target object (e.g., the image information 1111 about the target object) and information about the surrounding environment (e.g., the ambient information of the electronic device). In various embodiments of the disclosure, the generation model used to output the information about the movement (or motion) of the target object may also be represented as a motion generation model. The electronic device may obtain the content of the target object (e.g., the content 1131 of the target object) by applying the movement (or motion) of the target object to the information about the target object (e.g., the image information 1111 about the target object).

According to an embodiment, the electronic device may further obtain a sound 1132 corresponding to the content 1131 along with the content 1131 of the target object. For example, the electronic device may obtain the sound regarding a movement of a target object contained in content (e.g., a video) based on the obtained image information and ambient information of the electronic device. For example, the electronic device may obtain the sound including background music of content (e.g., an image) based on the obtained image information and ambient information of the electronic device. The electronic device may play the obtained sound along with the output of content. For example, the content generation model 1120 may be generated and/or trained to output output data including information about the content 1131 and the sound 1132 of the target object.

For example, when the target object is a plant pot and the content 1131 of the target object indicates a plant planted in the pot swaying in the wind, the sound 1132 may include the sound of wind and/or the sound of the plant's leaves colliding with the wind.

For example, when the target object is a waterfall and the content 1131 of the target object indicates a waterfall falling on a rainy day, the sound 1132 may include the sound of rain and/or the sound of falling water.

When a condition regarding the output of content is satisfied (e.g., when the operation mode of the electronic device changes from the first operation mode to the second operation mode), the electronic device may output the content 1131 of the target object and play the sound 1132.

FIG. 12 is a diagram illustrating an example of an operation in which an electronic device outputs content in an area larger than an area corresponding to a target object according to an embodiment of the disclosure.

Referring to FIG. 12, an electronic device (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5), according to an embodiment may output (e.g., display) content of a target object in an area larger than an area corresponding to the target object.

In FIG. 12, in a normal operation mode 1201, the electronic device may provide a user with a space including an interaction object 1212 and a target object, a poster 1211. For example, the poster 1211 may include a picture of a waterfall.

The electronic device may obtain image information including a scene contained in the internal area of the poster 1211. The electronic device may obtain ambient information of the electronic device. Based on the image information and the ambient information, the electronic device may obtain the content related to the scene with a visual property corresponding to weather or time indicated by the ambient information.

In various embodiments of the disclosure, it is mainly described that the content is generated based on the image information and the ambient information, but embodiments are not limited thereto. According to an embodiment, the electronic device may generate content based on the image information. For example, the electronic device may generate the content independently (e.g., regardless) of the ambient information.

The electronic device may change the operation mode of the electronic device from a normal operation mode 1201 to a relaxation operation mode 1202 based on a condition regarding the output of content (e.g., a condition corresponding to the transition from the normal operation mode 1201 to the relaxation operation mode 1202) being satisfied.

The electronic device may output the content in an area larger than the area corresponding to the target object in a display area of a display. In the relaxation operation mode 1202, the electronic device may deactivate the interaction object 1212 and output content 1213 of the target object (i.e., poster 1211) in an area larger than the area corresponding to the target object (i.e., poster 1211). In FIG. 12, for example, the content 1213 may include a video showing a waterfall falling.

The electronic device according to an embodiment may provide a user experience in the relaxation operation mode 1202 that is distinct from the normal operation mode 1201 by outputting the content of the target object in an area larger than the area corresponding to the target object. The electronic device may provide immersive content to the user by outputting the content over most of the area (e.g., the display area of the display) corresponding to a space provided to the user, as illustrated in FIG. 12. As a result, the user may be immersed in the content, which may alleviate the burden on the user regarding interaction with the electronic device or an interaction object provided by the electronic device.

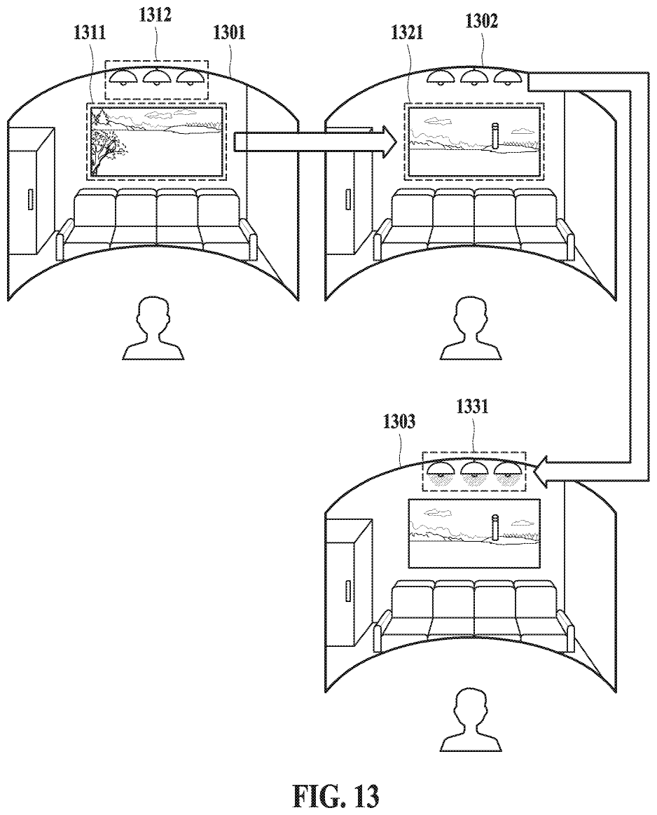

FIG. 13 is a diagram illustrating an example of a configuration in which an electronic device obtains and/or outputs content when a plurality of target objects are selected according to an embodiment of the disclosure.

Referring to FIG. 13, an electronic device (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5), according to the embodiment may obtain and output pieces of content of a plurality of target objects.

The electronic device may select a plurality of target objects from among physical objects.

In a normal operation mode 1301, the electronic device may provide a user with a space in which a light bulb 1312 and a poster 1311 are placed. The electronic device may select the light bulb 1312 and the poster 1311 as target objects among the physical objects. The poster 1311 may include a scene of a beach captured, in an internal area of the poster 1311.

The electronic device may obtain content for each of the plurality of selected target objects. For each of the plurality of target object, the electronic device according to an embodiment may obtain content of a target object based on image information about the target object and ambient information of the electronic device. The electronic device may obtain the content of the target object by applying input data for each target object to a content generation model (e.g., the content generation model 1120 of FIG. 11).

In FIG. 13, the ambient information of the electronic device may indicate the time of sunset. The electronic device may obtain content for the beach at sunset as content of the poster 1311. The electronic device may obtain content regarding the light bulb 1312 emitting light with the color of a light source of the sun at sunset, as content of the light bulb 1312.

According to an embodiment, when the plurality of target objects are selected, the electronic device may sequentially output the pieces of content of the target objects as conditions are sequentially satisfied. Priorities for the plurality of target objects may be determined, and based on the priorities, each target object may be replaced with the content of the corresponding target object.

The priorities for the plurality of target objects may be determined based on a size of an area corresponding to the plurality of target objects. For example, the larger the size of the area corresponding to the target object, the higher the priority of the target object may be determined.

The priority for the plurality of target objects may be determined based on a degree of relevance of each target object to the natural environment. For example, a first object including a plant may have a higher degree of relevance to the natural environment than a second object including a car. For example, a first object including a scene of a mountain or a beach may have a higher degree of relevance to the natural environment than a second object including a scene of a city.

For example, the electronic device may determine that an object or a scene included in an object belongs to at least one object set among a first object set related to the natural environment or a second object set not related to the natural environment. The first object set may include at least one of a plant, an animal, a tree, a forest, a mountain, an ocean, a sky, a sun, a moon, a star, or a cloud. The second object set may include at least one of a car, a building, steel, a factory, a machine, plastic, or an industrial product. The electronic device may determine the priority of a target object based on whether the target object belongs to the first object set or the second object set.

In FIG. 13, for example, the electronic device may determine the priority of the poster 1311 to be higher than the priority of the light bulb 1312.

The electronic device may output first content in an area corresponding to a first target object determined based on priorities of the plurality of target objects, based on a first condition regarding the output of the content being satisfied. The first condition may refer to a condition for outputting the content of the target object with the highest priority among the plurality of target objects.

In FIG. 13, the electronic device may change the operation mode of the electronic device from the normal operation mode 1301 to a first relaxation operation mode 1302 based on the first condition being satisfied. In the first relaxation operation mode 1302, the electronic device may output content 1321 of the poster 1311 in an area corresponding to the poster 1311. In the first relaxation operation mode 1302, the electronic device may limit the output of content 1331 of the light bulb 1312.

The electronic device may output second content in an area corresponding to a second target object determined based on priorities of the plurality of target objects, based on a second condition regarding the output of the content being further satisfied. The second condition may refer to a condition for outputting the content of the target object with the second highest priority among the plurality of target objects. According to an embodiment, the second condition may include that an additional condition corresponding to the second condition is further satisfied while the first condition is satisfied.

In FIG. 13, the electronic device may change the operation mode of the electronic device from the first relaxation operation mode 1302 to a second relaxation operation mode 1303 based on the second condition being satisfied. In the second relaxation operation mode 1303, the electronic device may output content 1331 of the light bulb 1312 in an area corresponding to the light bulb 1312.

According to an embodiment, the operation mode of the electronic device may be one of a normal operation mode or a plurality of relaxation operation modes of a plurality of levels. As the level of the relaxation operation mode increases, a difference from a space provided in the normal operation mode may become greater. For example, as the level of the relaxation operation mode increases, the number of interaction objects that are deactivated may increase, or the degree of deactivation of the interaction objects may increase (e.g., transparency of the interaction objects may increase or brightness of the interaction objects may decrease). As the level of the relaxation operation mode increases, the size of the area, in which the content of the target object is output, may increase.

When the first condition is satisfied, the electronic device may change the operation mode of the electronic device from the normal operation mode 1301 to the first relaxation operation mode 1302. The first condition may refer to a condition corresponding to the transition from the normal operation mode 1301 to the first relaxation operation mode 1302. For example, the first condition may include maintaining the gaze of the user on a specific area (e.g., an area other than the area corresponding to the interaction object) for a first threshold time. The first relaxation operation mode 1302 may be a relaxation operation mode at a lowest level among relaxation operation modes at the plurality of levels.

In the first relaxation operation mode 1302, the electronic device may output content for a target object with a highest priority among a plurality of target objects in an area corresponding to the target object with the highest priority. For example, in the first relaxation operation mode 1302, the electronic device may replace a target object (e.g., the poster 1311) assigned to the first relaxation operation mode 1302 with the content 1321.

When the second condition is further satisfied, the electronic device may change the operation mode of the electronic device from the first relaxation operation mode 1302 to the second relaxation operation mode 1303. The second condition may refer to a condition corresponding to raising the level of the relaxation operation mode (e.g., transitioning from the first relaxation operation mode 1302 to the second relaxation operation mode 1303). For example, the second condition may include not detecting an input of a user that triggers the operation of the electronic device during a second threshold time. The second relaxation operation mode 1303 may be a relaxation operation mode of a second lowest level among relaxation operation modes of a plurality of levels.

In the second relaxation operation mode 1303, the electronic device may output content for a target object with a second highest priority among the plurality of target objects in an area corresponding to the target object with the second highest priority. For example, in the second relaxation operation mode 1303, the electronic device may replace a target object (e.g., the light bulb 1312) assigned to the second relaxation operation mode 1303 with the content 1331. In the second relaxation operation mode 1303, the electronic device may maintain replacing a target object (e.g., the poster 1311) assigned to a relaxation operation mode (e.g., first relaxation operation mode 1302) at a lower level than the second relaxation operation mode 1303 with content (e.g., the content 1321).

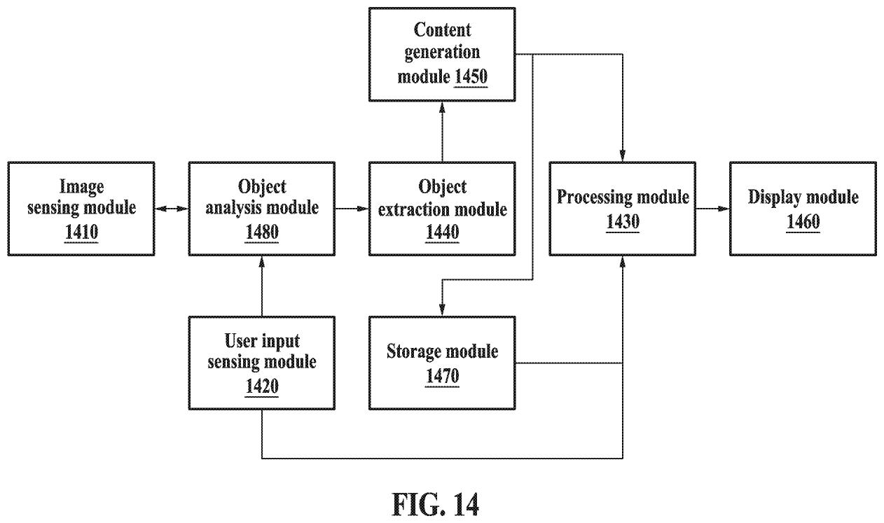

FIG. 14 is a block diagram illustrating an example of a configuration of an electronic device according to an embodiment of the disclosure.

Referring to FIG. 14, an electronic device according to an embodiment (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5) may include an image sensing module 1410, a user input sensing module 1420, a processing module 1430, an object extraction module 1440, a content generation module 1450, a display module 1460, a storage module 1470, and an object analysis module 1480.

The image sensing module 1410 may sense image data for a physical space and/or a physical object around the electronic device. For example, the image sensing module 1410 may include a camera sensor and/or a depth sensor. The image sensing module 1410 may transmit the image data to the object analysis module 1480.

The object analysis module 1480 may analyze the image data for the physical space and/or the physical object around the electronic device. The object analysis module 1480 may select a target object to be used to generate content from among physical objects.

The user input sensing module 1420 may sense (e.g., detect) an input of a user. The user input sensing module 1420 may transmit information about the detected input of the user to the processing module 1430. The user input sensing module 1420 may detect the satisfaction of a condition by monitoring the input of the user (e.g., a gaze input or a gesture input) when a condition corresponding to the transition between the operation modes of the electronic device is based on the input of the user.

The processing module 1430 may generate a stereoscopic image of a space to be provided to the user. The processing module 1430 may receive information about an interaction object from an external device or obtain the information from a storage. The processing module 1430 may generate and/or display a stereoscopic image including an interaction object.

The object extraction module 1440 may extract a target object from the image data and/or the stereoscopic image. The object extraction module 1440 may transmit image information corresponding to the target object (e.g., an image obtained by capturing the target object) to the content generation module 1450 by segmenting (e.g., cropping) an area corresponding to the target object from the image data.

The content generation module 1450 may generate content for the target object based on information about the target object (e.g., image information about the target object) and/or information about the surrounding environment (e.g., ambient information of the electronic device). The content generation module 1450 may transmit information about the generated content to the storage module 1470. In FIG. 14, it is described that the content generation module 1450 is included as a component of the electronic device (e.g., on-device), but embodiments are not limited thereto, and the content generation module 1450 may be included in another electronic device outside the electronic device (e.g., on-cloud).

The display module 1460 may display the generated content together with the target object, or display the generated content instead of the target object.

The storage module 1470 may store the information about the generated content.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment, the electronic device is not limited to those described above.

It should be understood that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., by wire), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a complier or code executable by an interpreter. A machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., CD-ROM), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The embodiments described herein may be implemented using a hardware component, a software component and/or a combination thereof. For example, the device, the method, and the components described in the embodiments may be implemented using a general-purpose or special-purpose computer, such as a processor, a controller, an arithmetic logic unit (ALU), a digital signal processor (DSP), a microcomputer, a field programmable gate array (FPGA), a programmable logic unit (PLU), a microprocessor, or any other device capable of responding to and executing instructions. The processing device may run an operating system (OS) and one or more software applications that run on the OS. The processing device may also access, store, manipulate, process, and generate data in response to execution of software. For purpose of simplicity, the description of a processing device is used as singular; however, one skilled in the art will appreciate that a processing device may include a plurality of processing elements and/or a plurality of types of processing elements. For example, the processing device may include a plurality of processors, or a single processor and a single controller. In addition, different processing configurations are possible, such as parallel processors.

Software may include a computer program, a piece of code, an instruction, or one or more combinations thereof, to individually or collectively instruct or configure the processing device to operate as desired. Software and/or data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored in a non-transitory computer-readable storage media.

The method according to the embodiments described above may be recorded in the non-transitory computer-readable storage media including program instructions to implement various operations of the embodiments described above. The media may also include, alone or in combination with the program instructions, data files, data structures, and the like. The program instructions recorded on the media may be those specially designed and constructed for the purposes of the examples, or they may be of the well-known kind and available to those having skill in the computer software arts. Examples of non-transitory computer-readable media include magnetic media such as hard disks, floppy disks, and magnetic tape, optical media such as compact disc read-only memory (CD-ROM) discs and digital video discs (DVDs), magneto-optical media such as floptical disks, and hardware devices that are specifically configured to store and perform program instructions, such as read-only memory (ROM), random access memory (RAM), flash memory, and the like. Examples of program instructions include both machine code, such as code produced by a compiler, and files including higher level code that may be executed by the computer using an interpreter.

The above-described hardware devices may be configured to act as one or more software modules in order to perform the operations of the above-described embodiments, or vice versa.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, comprising one or more storage media, storing instructions; and
one or more processors communicatively coupled to the display and the memory,
wherein the instructions, when executed by the one or more processors individually or collectively, cause the electronic device to:
obtain image information corresponding to a target object determined among physical objects disposed in a physical space around the electronic device,
obtain content related to the target object, based on the obtained image information and ambient information of the electronic device,
deactivate an interaction object being manipulable in response to an input of a user, based on a condition regarding an output of the content being satisfied, and
output the obtained content in an area corresponding to the target object through the display.

2. The electronic device of claim 1, wherein the condition regarding the output of the content comprises at least one of gaze of the user not pointing at the interaction object for a threshold time, biometric information of the user satisfying a predetermined condition, or no input of the user triggering an operation of the electronic device being detected from the user for a threshold time.

3. The electronic device of claim 1, wherein the instructions, when executed by the one or more processors individually or collectively, further cause the electronic device to:
display, through the display, a stereoscopic image for a space comprising a background based on the physical space around the electronic device and the interaction object, and
obtain the image information by segmenting a portion corresponding to the target object of the stereoscopic image.

4. The electronic device of claim 1, wherein the instructions, when executed by the one or more processors individually or collectively, further cause the electronic device to:
select a plurality of target objects among the physical objects,
obtain content for each of the plurality of selected target objects,
output first content in an area corresponding to a first target object determined based on priorities of the plurality of target objects, based on a first condition regarding output of the content being satisfied, and
output second content in an area corresponding to a second target object determined based on priorities of the plurality of target objects, based on a second condition regarding output of the content being further satisfied.

5. The electronic device of claim 1, wherein the instructions, when executed by the one or more processors individually or collectively, further cause the electronic device to:
obtain the image information comprising a scene, based on displaying the scene in an internal area of the target object,
obtain the ambient information comprising at least one of weather information or time information about a surrounding environment of the electronic device,
obtain, based on the image information and the ambient information, the content related to the scene with a visual property corresponding to weather or time indicated by the ambient information, and
output the content in the internal area of the target object.

6. The electronic device of claim 1, wherein the instructions, when executed by the one or more processors individually or collectively, further cause the electronic device to:
stop outputting the content, based on a condition regarding stopping the outputting of the content being satisfied, and
activate the interaction object.

7. The electronic device of claim 1, wherein the instructions, when executed by the one or more processors individually or collectively, further cause the electronic device to:
maintain a display of the interaction object, based on the interaction object being disposed in an aligned position according to a background within a space comprising the background based on the physical space and the interaction object, and
restrict the display of the interaction object, based on the interaction object being disposed in the aligned position according to the electronic device within the space.

8. The electronic device of claim 1, wherein the instructions, when executed by the one or more processors individually or collectively, further cause the electronic device to:
obtain, based on the obtained image information and the ambient information of the electronic device, a sound regarding a movement of the target object shown in the content; and
play the obtained sound in conjunction with the output of the content.

9. The electronic device of claim 1, wherein the instructions, when executed by the one or more processors individually or collectively, further cause the electronic device to:
output the content in an area among a display area of the display, wherein the area is larger than the area corresponding to the target object.

10. The electronic device of claim 1, wherein the instructions, when executed by the one or more processors individually or collectively, further cause the electronic device to:
change an operation mode of the electronic device from a first operation mode to a second operation mode, based on a condition corresponding to a transition from the first operation mode to the second operation mode being satisfied when the operation mode of the electronic device is the first operation mode;
perform the output of the content and the deactivation of the interaction object while the operation mode of the electronic device is the second operation mode;
change the operation mode of the electronic device from the second operation mode to the first operation mode, based on a condition corresponding to a transition from the second operation mode to the first operation mode being satisfied when the operation mode of the electronic device is the second operation mode; and
restrict the output of the content in the area corresponding to the target object and activate the interaction object while the operation mode of the electronic device is the first operation mode.

11. A method performed by an electronic device, the method comprising:
obtaining image information corresponding to a target object determined among physical objects disposed in a physical space around the electronic device;
obtaining content related to the target object, based on the obtained image information and ambient information of the electronic device;
deactivating an interaction object being manipulable in response to an input of a user based on a condition regarding an output of the content being satisfied; and
outputting the obtained content in an area corresponding to the target object through a display.

12. The method of claim 11, wherein the condition regarding the output of the content comprises at least one of gaze of the user not pointing at the interaction object for a threshold time, biometric information of the user satisfying a predetermined condition, or no input of the user triggering an operation of the electronic device being detected from the user for a threshold time.

13. The method of claim 11, wherein the obtaining of the image information comprises:
displaying, through the display, a stereoscopic image for a space comprising a background based on the physical space around the electronic device and the interaction object; and
obtaining the image information by segmenting a portion corresponding to the target object of the stereoscopic image.

14. The method of claim 11,
wherein the outputting of the content comprises:
selecting a plurality of target objects among the physical objects, and
obtaining content for each of the plurality of selected target objects, and wherein the outputting of the obtained content comprises:
outputting first content in an area corresponding to a first target object determined based on priorities of the plurality of target objects, based on a first condition regarding output of the content being satisfied, and
outputting second content in an area corresponding to a second target object determined based on priorities of the plurality of target objects, based on a second condition regarding output of the content being further satisfied.

15. The method of claim 11,
wherein the obtaining of the image information comprises obtaining the image information comprising a scene, based on displaying the scene in an internal area of the target object,
wherein the obtaining of the content comprises:
obtaining the ambient information comprising at least one of weather information or time information about a surrounding environment of the electronic device, and
obtaining, based on the image information and the ambient information, the content related to the scene with a visual property corresponding to weather or time indicated by the ambient information, and
wherein the outputting of the content comprises outputting the content in the internal area of the target object.

16. The method of claim 11, further comprising:
stopping outputting the content, based on a condition regarding stopping the outputting of the content being satisfied.

17. The method of claim 11, wherein the deactivating of the interaction object comprises:
maintaining a display of the interaction object, based on the interaction object being disposed in an aligned position according to a background within a space comprising the background based on the physical space and the interaction object; and
restricting the display of the interaction object, based on the interaction object being disposed in the aligned position according to the electronic device within the space.

18. The method of claim 11, further comprising:
obtaining, based on the obtained image information and the ambient information of the electronic device, a sound regarding a movement of the target object shown in the content; and
playing the obtained sound in conjunction with the output of the content.

19. The method of claim 11,
wherein the outputting of the content comprises outputting the content in an area among a display area of the display, and
wherein the area is larger than the area corresponding to the target object.

20. One or more non-transitory computer-readable storage media storing one or more computer programs including computer-executable instructions that, when executed by one or more processors of an electronic device individually or collectively, cause the electronic device to perform operations, the operations comprising:
obtaining image information corresponding to a target object determined among physical objects disposed in a physical space around the electronic device;
obtaining content related to the target object, based on the obtained image information and ambient information of the electronic device;
deactivating an interaction object being manipulable in response to an input of a user based on a condition regarding an output of the content being satisfied; and
outputting the obtained content in an area corresponding to the target object through a display.
